(19) United States
(12) Patent Application Publication
(10) Pub. No.: US 2016/0257872 A9
(43) Pub. Date: Sep. 8, 2016

(54) SOLID STATE DISPERSION

(71) Applicant: Schlumberger Technology Corporation, Sugar Land, TX (US)

(72) Inventors: Shitong Sherry Zhu, Waban, MA (US); Yiyan Chen, Sugar Land, TX (US); John David Rowatt, Harvard, MA (US); Francois M. Auzerais, Boston, MA (US); Huilin Tu, Sugar Land, TX (US); Miranda Amarante, Somerville, MA (US); Meng Qu, Dorchester, MA (US); Simone Musso, Cambridge, MA (US)

(73) Assignee: Schlumberger Technology Corporation, Sugar Land, TX (US)

(21) Appl. No.: 13/951,940

(22) Filed: Jul. 26, 2013

Related U.S. Application Data
(63) Continuation-in-part of application No. 12/884,917, filed on Sep. 17, 2010.

(51) Int. Cl. C09K 8/68; E21B 43/267

(52) U.S. Cl. CPC C09K 8/68; E21B 43/267

(57) ABSTRACT

A composition comprising, and methods of producing a solid state dispersion comprising particles dispersed in a water soluble polymer. Treatment fluids comprising, and methods of using the solid state dispersion are also disclosed.

### BACKGROUND

The statements in this section merely provide background information related to the present disclosure and may not constitute prior art.

The use of treatment fluids in general, and high solids content treatment fluids in particular, may benefit from very good leak off control properties to inhibit fluid loss, as well as good stability, minimal settling of solids, suitable rheological properties for pumping with oilfield equipment, and/or good permeability of a solids pack after placement. Formation of the treatment fluid and the inclusion of the various components is often challenging. Accordingly, there is a demand for further improvements in this area of technology.

### SUMMARY

In various embodiments, a solid state dispersion according to the instant disclosure comprises a plurality of particles dispersed in a matrix comprising a water soluble polymer. In an embodiment, the plurality of particles comprise a hydrolyzable polymer. In an embodiment, the solid state dispersion may be produced by dispersing at least one component as a discontinuous phase within a continuous phase comprising a water soluble polymer. The solid state dispersion may then be combined with an aqueous fluid such that the dissolution of the solid state dispersion produces at least a portion of a treatment fluid. The solid state dispersion may be produced by melt extrusion of the first component with the water soluble polymer followed by cooling of extrudate to produce the solid state dispersion. In an embodiment, the minor or discontinuous phase of the degradable polymer is dispersed as discrete particles and/or droplets in the water soluble polymer phase when in the solid state. The dissolution of the solid state dispersion in an aqueous fluid to produce a treatment fluid results in a treatment fluid comprising an emulsion with the discontinuous phase particles, which may include degradable polymer particles, dispersed in the aqueous fluid. By selecting the appropriate dispersed phase, which may include a hydrolyzable polymer, also referred to as degradable polymer, and the appropriate water soluble polymer, and/or other components, the solid state dispersion according to the instant disclosure may be used to produce a treatment fluid which provides a degradable emulsion for fluid loss control, delivering multimodal solid particles, developing on-demand gels, producing various other treatment fluids, and the like.

In some embodiments herein, the treatments, treatment fluids, systems, equipment, methods, and the like comprise a stabilized treatment slurry (STS) wherein the solid phase, which may include proppant, and/or the particles supplied by dissolution of the solid state dispersion, is at least temporarily inhibited from gravitational settling in the fluid phase. In some embodiments, the STS may have an at least temporarily controlled rheology, such as, for example, viscosity, leakoff or yield strength, or other physical property, such as, for example, specific gravity, solids volume fraction (SVF), or the like. In some embodiments, at least a portion of the solids phase of the STS may be provided by dissolution of one or more embodiments of the solid state dispersion as disclosed herein, to provide an STS having an at least temporarily controlled property, such as, for example, particle size distribution (including modality(ies)), packed volume fraction (PVF), density(ies), aspect ratio(s), sphericity(ies), roundness(es) (or angularity(ies)), strength(s), permeability(ies), solubility(ies), reactivity(ies), and the like. In an embodiment, the solid state dispersion disclosed herein may provide any portion of the solids phase, one or more rheologically active components of the STS, and/or other components of the STS via dissolution of one or more embodiments of the solid state dispersion disclosed herein.

### BRIEF DESCRIPTION OF THE DRAWINGS

These and other features and advantages will be better understood by reference to the following detailed description when considered in conjunction with the accompanying drawings.

FIG. 1 shows a schematic slurry state progression chart for a treatment fluid according to some embodiments of the current application.

FIG. 2 illustrates fluid stability regions for a treatment fluid according to some embodiments of the current application.

FIG. 3 shows the leakoff property of a low viscosity, stabilized treatment slurry (STS) (lower line) according to some embodiments of the current application compared to conventional crosslinked fluid (upper line).

FIG. 4 shows a schematic representation of the wellsite equipment configuration with onsite mixing of an STS according to some embodiments of the current application.

FIG. 5 shows a schematic representation of the wellsite equipment configuration with a pump-ready STS according to some embodiments of the current application.

FIG. 6 is a plot of the particle size distribution and the number average particle size of an exemplary embodiment.

FIG. 7 is a plot of the particle size distribution and the number average particle size of an exemplary embodiment.

FIG. 8 shows the change of the average particle size of an emulsion after three days according to an embodiment of the instant disclosure.

### DETAILED DESCRIPTION OF SOME ILLUSTRATIVE EMBODIMENTS

For the purposes of promoting an understanding of the principles of the disclosure, reference will now be made to some illustrative embodiments of the current application. Like reference numerals used herein refer to like parts in the various drawings. Reference numerals without suffixed letters refer to the part(s) in general; reference numerals with suffixed letters refer to a specific one of the parts.

As used herein, “embodiments” refers to non-limiting examples of the application disclosed herein, whether claimed or not, which may be employed or present alone or in any combination or permutation with one or more other embodiments. Each embodiment disclosed herein should be regarded both as an added feature to be used with one or more other embodiments, as well as an alternative to be used separately or in lieu of one or more other embodiments. It should be understood that no limitation of the scope of the claimed subject matter is thereby intended, any alterations and further modifications in the illustrated embodiments, and any further applications of the principles of the application as illustrated therein as would normally occur to one skilled in the art to which the disclosure relates are contemplated herein.

Moreover, the schematic illustrations and descriptions provided herein are understood to be examples only, and components and operations may be combined or divided, and added or removed, as well as re-ordered in whole or part, unless stated explicitly to the contrary herein. Certain operations illustrated may be implemented by a computer executing a computer program product on a computer readable medium, where the computer program product comprises instructions causing the computer to execute one or more of the operations, or to issue commands to other devices to execute one or more of the operations.

It should be understood that, although a substantial portion of the following detailed description may be provided in the context of oilfield hydraulic fracturing operations, other oilfield operations such as cementing, gravel packing, etc., or even non-oilfield well treatment operations, can utilize and benefit as well from the instant disclosure.

As used herein, the terms “treatment fluid” or “wellbore treatment fluid” are inclusive of “fracturing fluid” or “treatment slurry” and should be understood broadly. These may be or include a liquid, a solid, a gas, and combinations thereof, as will be appreciated by those skilled in the art. A treatment fluid may take the form of a solution, an emulsion, slurry, or any other form as will be appreciated by those skilled in the art.

As used herein, “slurry” refers to an optionally flowable mixture of particles dispersed in a fluid carrier. The terms “flowable” or “pumpable” or “mixable” are used interchangeably herein and refer to a fluid or slurry that has either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

“Viscosity” as used herein unless otherwise indicated refers to the apparent dynamic viscosity of a fluid at a temperature of 25° C. and shear rate of 170 s⁻¹. “Low-shear viscosity” as used herein unless otherwise indicated refers to the apparent dynamic viscosity of a fluid at a temperature of 25° C. and shear rate of 5.11 s⁻¹. Yield stress and viscosity of the treatment fluid are evaluated at 25° C. in a Fann 35 rheometer with an R1B5F1 spindle, or an equivalent rheometer/spindle arrangement, with shear rate ramped up to 255 s⁻¹ (300 rpm) and back down to 0, an average of the two readings at 2.55, 5.11, 85.0, 170 and 255 s⁻¹ (3, 6, 100, 200 and 300 rpm) recorded as the respective shear stress, the apparent dynamic viscosity is determined as the ratio of shear stress to shear rate (τ/γ) at γ=170 s⁻¹, and the yield stress (τ₀) (if any) is determined as the y-intercept using a best fit of the Herschel-Buckley rheological model, τ=τ₀+k(γ)ⁿ, where τ is the shear stress, k is a constant, γ is the shear rate and n is the power law exponent. Where the power law exponent is equal to 1, the Herschel-Buckley fluid is known as a Bingham plastic. Yield stress as used herein is synonymous with yield point and refers to the stress required to initiate flow in a Bingham plastic or Herschel-Buckley fluid system calculated as the y-intercept in the manner described herein. A “yield stress fluid” refers to a Herschel-Buckley fluid system, including Bingham plastics or another fluid system in which an applied non-zero stress as calculated in the manner described herein is required to initiate fluid flow.

The following conventions with respect to treatment fluid terms are intended herein unless otherwise indicated explicitly or implicitly by context.

“Treatment fluid” or “fluid” (in context) refers to the entire treatment fluid, including any proppant, subproppant particles, liquid, gas etc. “Whole fluid,” “total fluid” and “base fluid” are used herein to refer to the fluid phase plus any subproppant particles dispersed therein, but exclusive of proppant particles. “Carrier,” “fluid phase” or “liquid phase” refer to the fluid or liquid that is present, which may comprise a continuous phase and optionally one or more discontinuous fluid phases dispersed in the continuous phase, including any solutes, thickeners or colloidal particles only, exclusive of other solid phase particles; reference to “water” in the slurry refers only to water and excludes any particles, solutes, thickeners, colloidal particles, etc.; reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The term “dispersion” means a mixture of one substance dispersed in another substance, and may include colloidal or non-colloidal systems. The term “fines dispersion” refers to a dispersion of particles having particle diameters of 20 microns or smaller; “fines” refers to the dispersed particles in a fines dispersion. As used herein, “colloidal systems” comprise a dispersed phase having particle diameters of 20 microns or smaller evenly dispersed in a continuous phase; “colloids” refers to the dispersed particles in a colloid system. The terms “fines emulsion”, “sol”, “hydrosol” (where the continuous phase is aqueous) and “colloidal emulsion” are used interchangeably herein to refer to colloidal systems with solid and/or liquid particles dispersed therein.

As used herein, “emulsion” generally means any system with one liquid phase dispersed in another immiscible liquid phase, and may apply to oil-in-water and water-in-oil emulsions. Invert emulsions refer to any water-in-oil emulsion in which oil is the continuous or external phase and water is the dispersed or internal phase. As used herein unless otherwise specified, as described in further detail herein, particle size and particle size distribution (PSD) mode refer to the median volume averaged size. The median size used herein may be any value understood in the art, including for example and without limitation a diameter of roughly spherical particulates. In an embodiment, the median size may be a characteristic dimension, which may be a dimension considered most descriptive of the particles for specifying a size distribution range.

As used herein, the term “packing volume factor” or “packed volume fraction”, abbreviated “PVF” refers to the packed volume fraction of a randomly packed mixture of solids having a multimodal volume-averaged particle size distribution.

As used herein, the terms “Apollonianistic,” “Apollonianistic packing,” “Apollonianistic rule,” “Apollonianistic particle size distribution,” “Apollonianistic PSD” and similar terms refer to a multimodal volume-averaged particle size distribution with PSD modes that are not necessarily strictly Apollonian wherein either (1) a first PSD mode comprises solids having a volume-averaged median size at least one and a half larger (1.5×), or at least three times larger (3×) than the volume-average median size of at least a second PSD mode such that a PVF of the solids mixture exceeds 0.75 or (2) the solids mixture comprises at least three PSD modes, wherein a first amount of particulates have a first PSD, a second amount of particulates have a second PSD, and a third amount of particulates have a third PSD, wherein the first PSD is from two to ten times larger than the second PSD, and wherein the second PSD is at least 1.5 times larger than the third PSD. High solids content fluids (HSCF) typically comprise a plurality of Apollonianistic particle size distribution modes.

The term “solid state dispersion” refers to an immiscible blend comprising a discontinuous phase dispersed in a continuous polymer phase. The discontinuous phase, in liquid, solid or semi-solid form, includes discrete particles of one or more materials dispersed within a continuous phase comprising one or more water soluble polymers. The particles and the water soluble polymers may be immiscible, partially miscible, or miscible with the continuous phase under the conditions in which the solid state dispersion is formed. A solid state dispersion may be produced, for example, by melt extrusion wherein a solid discontinuous phase and a polymeric continuous phase, and/or two types of polymers are blended together in an extruder or other mixing equipment under conditions sufficient to melt or otherwise liquefy the continuous phase and disperse the discontinuous phase therein, followed by cooling the dispersion and/or drying the dispersion to form the solid state dispersion.

As used herein, a “water soluble polymer” refers to a polymer which has a water solubility of at least 5 wt % (0.5 g polymer in 9.5 g water) at 25° C.

The measurement or determination of the viscosity of the liquid phase (as opposed to the treatment fluid or base fluid) may be based on a direct measurement of the solids-free liquid, or a calculation or correlation based on a measurement(s) of the characteristics or properties of the liquid containing the solids, or a measurement of the solids-containing liquid using a technique where the determination of viscosity is not affected by the presence of the solids. As used herein, solids-free for the purposes of determining the viscosity of the liquid phase means in the absence of non-colloidal particles larger than 1 micron such that the particles do not affect the viscosity determination, but in the presence of any submicron or colloidal particles that may be present to thicken and/or form a gel with the liquid, i.e., in the presence of ultrafine particles that can function as a thickening agent. In some embodiments, a “low viscosity liquid phase” means a viscosity less than about 300 mPa-s measured without any solids greater than 1 micron at 170 s⁻¹ and 25° C.

### Solid State Dispersion Composition

The present disclosure in various embodiments describes compositions comprising a solid state dispersion, and methods, slurries, treatment fluids, and systems which may utilize one or more of the compositions for use in fracturing, gravel packing or frac-packing as well as using the compositions in formation of treatment fluids, which include slurries. In an embodiment, the solid state dispersion may contain particles suitable for use in producing treatment fluids comprising a high fraction of solids, which may include comprising an Apollonianistic PSD, and may further include a fluid loss control agent, which may further include a fluid loss control agent comprising a hydrolyzable polymer, copolymer, or mixtures thereof.

In one embodiment, the treatment fluid comprises a solid state dispersion according to one or more embodiments disclosed herein. It is to be understood that a treatment fluid comprising a solid state dispersion is to be interpreted as, or refers to a treatment fluid comprising components provided to the treatment fluid by dissolution of at least a portion of a solid state dispersion in a carrier fluid. In an embodiment, a treatment fluid comprising a solid state dispersion comprises a solids mixture comprising a plurality of particles comprising a plurality of volume-average particle size distribution (PSD) modes such that a packed volume fraction (PVF) of the solids mixture exceeds 0.8. In another embodiment, the smaller PSD modes comprise hydrolyzable polymer particles provided by the solid state dispersion, which can be removed from a pack formed by the treatment fluid to increase porosity and permeability of the pack and therefore, increase the flow of fluids through the pack.

In one embodiment, a composition comprises a solid state dispersion comprising a plurality of particles dispersed in a matrix comprising a water soluble polymer. In an embodiment, a composition comprises a solid state dispersion comprising a plurality of a hydrolyzable polymer particles dispersed in a matrix comprising a water soluble polymer.

In an embodiment, the solid state dispersion comprises particles of a hydrolyzable polymer having an average particle size from about 0.01 microns to about 20 microns.

In an embodiment, the solid state dispersion comprises from about 1 wt % to 90 wt % of the hydrolyzable polymer, based on the total weight of the solid state dispersion composition.

In an embodiment, the solid state dispersion according to any embodiment disclosed herein may comprise an Apollonianistic mixture of particles comprising first and second particle size distribution modes wherein the first particle size distribution mode is at least 1.5 times larger, or at least 3 times larger, or from about 1.5 to 25 times larger, or about 3 to 20 times larger, or about 3 to 15 times larger, or about 7 to 10 times larger, or about 1.5 to 2.5 times larger than the second particle size distribution mode. In an embodiment, the particles comprise a hydrolyzable polymer, which comprises at least one particle size distribution mode of the Apollonianistic mixture of particles.

In an embodiment, the solid state dispersion is a melt extrudate, a granulated particle, a pellet, a brick, an article, a compacted article, and/or the like.

In an embodiment, the solid state dispersion includes a mixture or blend of at least two polymers or copolymers comprising more than 1 wt % of each component. The two polymers in the blend may be miscible i.e., thermodynamically stable with a negative Gibbs free energy; or immiscible i.e., having a positive Gibbs free energy.

In an embodiment, the solid state dispersion may further include various sized particles, which may include micron or submicron sized particles such as, for example, silicates, γ-alumina, MgO, γ-Fe₂O₃, TiO₂ and combinations thereof; hydratable polymer particles, e.g., polymer particles having a hydration temperature above 60° C. such as gellan gum; high aspect ratio particles, e.g. an aspect ratio above 6, such as, for example, flakes or fibers; and/or a plurality of different types of degradable particles.

In one embodiment, the solid state dispersion may comprise a solids mixture having an Apollonianistic PSD, wherein the particles of the hydrolyzable polymer comprise at least one particle size distribution mode of the Apollonianistic mixture of particles. In an embodiment the hydrolyzable polymer may be referred to as a fluid loss control agent, wherein the solids mixture comprises a degradable material and may further include a reactive solid.

In one embodiment, the solid state dispersion may include a stabilizer agent, which may be an anionic surfactant, selected to stabilize the hydrolyzable particle or other particles upon dilution of the dispersion in a carrier fluid.

### Hydrolyzable Polymer

In an embodiment, the composition comprises a hydrolyzable polymer, also referred to as a “labile polymer” or a “degradable polymer”, which refers to a polymer in which the molecular weight is reduced by cleaving of at least some of the bonds between at least some of the polymerized monomers upon contact with a particular agent, i.e., a solvent, an acid, a base, an oxidizing agent, a reducing agent, or any combination thereof. For purposes herein, a hydrolyzable polymer need not undergo actual chemical hydrolysis (i.e., the addition of water across a chemical bond), but implies cleavage of a chemical bond or crosslink reducing the overall molecular weight of the polymer. Upon hydrolysis, a hydrolyzable polymer has an increased water solubility, and/or a reduction in actual size of a particle of the polymer. Hydrolysis may occur upon contact with a particular agent, i.e., a solvent, an acid, a base, an oxidizing agent, a reducing agent, or any combination thereof, under suitable conditions of temperature, concentration, and/or time.

In one embodiment, the hydrolyzable particle material has a lower solubility in an aqueous carrier fluid compared to the water solubility of the water-soluble polymer in the aqueous carrier fluid. In an embodiment, the hydrolyzable particle has a solubility of less than 1 wt % in water at 25° C., or less than 0.1 wt % in water at 25° C. The hydrolyzable particle can, however, be at least partially dissolved or otherwise degraded by the environment in which the particle is located, including changing the pH in the environment, e.g., in the solids pack. For example, the polymer particles may be insoluble at a neutral pH, but may become water soluble at a high, and/or at a low pH. In other embodiments, the degradable material is soluble in acidic fluids having a pH of less than 2, or in basic fluids having a pH greater than 10. The solid state dispersion may further include an acid precursor, a base precursor, or the like, which is optionally sparingly soluble and/or encapsulated such that upon contact with a fluid, the acid or base is released after an appropriate time. In an embodiment, the hydrolyzable polymer is acid labile.

In a particular embodiment, the hydrolyzable polymer comprises a polyester. In an embodiment, the hydrolyzable polymer comprises polylactic acid, polyglycolic acid, polycarprolactone, polybutylene succinate, polybutylene succinate-co-adipate, polyhydroxyalkanoate polymers, copolymers thereof, or a combination thereof.

In an embodiment, the hydrolyzable polymer is immiscible with the water soluble polymer.

In an embodiment, the hydrolyzable polymer present in the composition has an average particle size from about 0.001 microns to about 20 microns. In an embodiment, the hydrolyzable polymer has a lower average particle size from about 0.005 microns, or about 0.01 microns, or about 0.05 microns, or about 0.01 microns, or about 0.5 microns; and a upper average particle size of about 15 microns, or about 10 microns, or about 5 microns, or about 1 micron, or about 0.5 microns, or about 0.1 microns. Accordingly, in an embodiment, the hydrolyzable polymer may have an average particle size distribution above the micron range, in the micron range, the submicron range, or the nano-sized range.

In an embodiment the solid state dispersion may include hydrolyzable particles which further may include a surfactant and optionally a plasticizer. For example, in an embodiment, the solid state dispersion may include polylactic acid (PLA) particles formed by grinding or cryo-grinding of PLA pellets, which have been treated with a surfactant, plasticizer or a combination thereof to enable dispersion upon dissolution of the composition, e.g., in a hydrosol or fines emulsion. Alternatively or additionally, the PLA or other particles can be formed by mixing a solution of the PLA in a solvent with an antisolvent or immiscible liquid, or as a melt in an immiscible polymer under high shear conditions, optionally in the presence of a surfactant, plasticizer or combination thereof, to produce microparticles in the desired PSD mode which may be dispersed in-situ into the continuous phase, or which may then be subsequently incorporated into the continuous phase of the solid state dispersion.

Pretreatment of the PLA particles with surfactant and/or addition of the PLA to the solid state dispersion, e.g., a concentrated masterbatch of from 5 to 60 or from 10 to 50 weight percent solids, or from 20 to 40 weight percent solids, may facilitate dispersion into the dispersion and subsequently a treatment fluid comprising the dispersion. Pretreatment of the hydrolyzable particles may also contribute to stability of a treatment fluid comprising the dispersion. The surfactant can additionally or alternatively be added to the treatment fluid separately before or after combining the dispersion.

Surfactants used to treat the PLA particles or which are suitable for use in the solid state dispersion may be cationic, zwitterionic, amphoteric, anionic, nonionic or the like. Some non-limiting examples are those cited in U.S. Pat. No. 6,435,277 (Qu et al.) and U.S. Pat. No. 6,703,352 (Dahayanake et al.), each of which are incorporated herein by reference. In an embodiment, the PLA-treating or pretreating surfactants are nonionic or anionic. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

In an embodiment, the solid state dispersion composition may include a nonionic surfactant, which may be one or more of alkyl alcohol ethoxylates, alkyl phenol ethoxylates, alkyl acid ethoxylates, alkyl amine ethoxylates, sorbitan alkanoates, ethoxylated sorbitan alkanoates, or the like. The nonionic surfactant in one embodiment may be an alkoxylate such as octyl phenol ethoxylate or a polyoxyalkylene such as polyethylene glycol or polypropylene glycol, or a mixture of an alkoxylate or a plurality of alkoxylates with a polyoxyalkylene or a plurality of polyoxyalkylenes, e.g., a mixture of octyl phenol ethoxylate and polyethylene glycol. The nonionic surfactant may also function as a plasticizer which may facilitate formation of a PLA film at the formation surface or deformation of the PLA particles to plug the pore throats or interstitial spaces within the solids pack, produced by a treatment fluid produced by dissolution of the solid state dispersion according to the instant disclosure.

Examples of degradable materials which may be present as the discontinuous phase of the solid state dispersion included wax, oil-soluble resin, materials soluble in hydrocarbons, lactide, glycolide, aliphatic polyester, poly(lactide), poly(glycolide), poly(ε-caprolactone), poly(orthoester), poly(hydroxybutyrate), aliphatic polycarbonate, poly(phosphazene), poly(anhydride), poly(saccharide), dextran, cellulose, chitin, chitosan, protein, poly(amino acid), poly(ethylene oxide), and copolymers including poly(lactic acids) and/or poly(glycolic acids), and the like. In an embodiment, degradable materials may include a copolymer including a first moiety that is a hydroxyl group, a carboxylic acid group, and/or a hydrocarboxylic acid group, and a second moiety that is a glycolic acid and/or a lactic acid.

In an embodiment, the solid state dispersion may include plasticizers in addition to any surfactant, one or more of the plurality of particles, e.g., PLA fines, may be treated or pretreated with polyethylene glycol, polypropylene glycol, a fatty acid ester, lactide monomer, glycolide monomer, citric acid ester, epoxidized oil, adipate ester, azaleate ester, acetylated coconut oil, or combinations thereof or the like. The plasticizer may be blended with the PLA in the solid state dispersion, in a PLA emulsion or masterbatch used to produce the solid state dispersion, or the like. The plasticizer can additionally or alternatively be added to the well treatment fluid separately before or after introducing the solid state dispersion.

In an embodiment, the solid state dispersion according to any embodiment disclosed herein may further comprise from about 0.01 wt % to about 50 wt % of a dispersant, a surfactant, a viscosifier, a defoamer, a plasticizer, or a combination thereof, based on the total weight of the composition. In an embodiment, the solid state dispersion may incorporate the surfactant and/or a plasticizer or blend of surfactants and/or plasticizers in an amount of about 0.01 wt % to about 50 wt % of total weight.

In an embodiment, the solid state dispersion may comprise an amount of surfactant suitable to produce an emulsion upon dissolution in a carrier fluid. Accordingly, the solid state dispersion may form micelles comprising PLA or other particles, for example, where the resulting PLA solution is immiscible in the continuous phase liquid, e.g. water. The liquid-in-liquid emulsion may be stabilized with a surfactant, dispersant or the like which may be present within the micelles, in the continuous phase, at an interface between the micelles and the continuous phase, or a combination thereof.

The solid state dispersion may be added to the carrier fluid, in one embodiment, may form heterogeneous micelles or dispersed particles or particle aggregates comprising the surfactant and the PLA particles, and/or such heterogeneous micelles may form in the treatment fluid. These liquid and/or heterogeneous micelles may function as particles in the treatment fluid or proppant pack to plug pore throats in the packed solids and/or in the formation. The size of the PLA particles and/or the micelles can be selected to give the best performance. For example, the size of the micelles can be controlled by the surfactant selection. The micelles and the PLA particles, especially plasticized PLA solids, can also have certain flexibility or pliability to deform and seal non-exact size or irregularly shaped pore throats.

The solid state dispersion may be used to produce a fluid loss control agent and system suitable for use in one embodiment with high solids content fluid (HSCF) systems or Apollonianistic systems, but in other embodiments can be used in other fluids or treatment fluids.

In an embodiment, the hydrolyzable particles and micelles formed by dissolution of the solid state dispersion may be degraded, destroyed or otherwise removed from a pack formed thereby, after, for example, well stimulation. For example, PLA hydrolyzes in the presence of water at elevated temperatures, and the PLA properties can be tailored to hydrolyze at the formation temperature and fluid chemistry in the particular downhole conditions to achieve complete hydrolysis in the desired time frame while allowing sufficient delay to complete placement and other steps in the stimulation operation. The surfactant micelles can be destroyed by the presence of hydrocarbons, such as from the formation, reaction with a de-emulsifier, degradation of the surfactant, or the like. As one example, the PLA hydrolysis products are organic acids which can interfere with and alter the micelle structure. Acid precursors can also be present in the intermediate sized particles in the Apollonianistic solids, for example.

In some embodiments, the surfactant micelles and/or PLA or other particles stabilized by surfactant are used as a fluid control agent. The micelles formed this way can be controlled by the specific surfactant used, amount of discontinuous phase etc. A wide spectrum of micelle sizes and geometries can be achieved in this way. Since the heterogeneous micelles formed here are based on self-assembly with Van der Walls force, they are not entirely rigid. The suspended PLA particles can also be pliable where suitable plasticized. Under certain pressure, the micelles and/or the PLA particles can actually deform to accommodate some shape changes. The micelles and/or particles formed in this way will help fluid loss control by both plugging the size-specific pore throats and being pliable to seal holes that are not a perfect fit. Stated differently, in an embodiment the solid state dispersion may be utilized to produce a fluid loss control system having filming and particle characteristics similar to latex so that it can form “film-like” low permeability layer during stimulation treatments, and yet the resulting “film” will not have the permanence characteristics of a latex film and can be easily removed at downhole conditions to restore permeability.

### Water Soluble Polymer

In an embodiment, the water soluble polymer or polymers present in the solid state dispersion have a water solubility of greater than or equal to about 5 wt % at 25° C. Suitable water soluble polymers include polyvinyl alcohol, polyethylene oxide, sulfonated polyester, polyacrylic ester/acrylic acid copolymer, polyacrylic ester/methacrylic acid copolymer, polyethylene glycol, poly (vinyl pyrrolidone), polylactide-co-glycolide, ethyl cellulose, hydroxypropylcellulose, hydroxypropylmethylcellulose, aminomethacrylatecolpolymer, polydimethlyaminoethylmethacrylate-co-methacrylicester, polymethacyrlicacid-co-methylmethacrylate, guar, hydroxyethylcellulose, xanthan, or a combination thereof.

In addition to providing a carrier for the hydrolyzable or other particles present in the composition, the water soluble polymer may be selected to facilitate emulsification of hydrolyzable particles, to provide stability to the resultant treatment fluid, or the like. The water soluble polymer may be selected and/or blended to provide a desired dissolution profile, environmental profile, extrusion profile, granulation profile, storage profile, compatibility profile, and/or the like, depending on the intended end use and properties desired.

### Formation of the Solid State Dispersion

In an embodiment, the solid state dispersion may be produced by incorporating or otherwise dispersing the discontinuous phase particles into the continuous phase comprising a water soluble polymer. In an embodiment, the solid state dispersion may be produced by melt extrusion of one or more water soluble polymers and one or more particles, which may include degradable polymers. The melt extrusion may be conducted utilizing an admixture of the components, and/or by sequentially adding various components at different times and/or by adding various components or combination of components at different processing conditions during the extrusion process. Accordingly, in an embodiment, the extrusion temperature, speed, auger configuration, die design, dimensions, pressure, and other process parameters may be selected to affect the phase separation and the size of the dispersed polymer droplets in the blend. In an embodiment, the processing conditions in producing the solid state dispersion may be selected and controlled to produce a solid state dispersion have a one or more desired particle size distribution (PSD) modes of one or more polymers, including a hydrolyzable polymer. In an embodiment, the melt from which the solid state dispersion is produced includes the melted water soluble polymer and the hydrolyzable polymer at a temperature below the glass transition temperature of the hydrolyzable polymer, such that the hydrolyzable polymer is present as a particle during the extrusion process. In an embodiment, a plasticizer, surfactant, dispersant, lubricant, co-solvent, and/or the like may be included to ensure the hydrolyzable polymer is dispersed as a discontinuous phase within the continuous phase comprising a water soluble polymer.

In an embodiment, the melt from which the solid state dispersion is produced includes the melted water soluble polymer and the hydrolyzable polymer at a temperature above the glass transition temperature of the hydrolyzable polymer such that the PSD of the resultant hydrolyzable polymer is controlled by interfacial surface tension, relative solubility, shear and/or mixing present during the extrusion process.

In an embodiment, the solid state dispersion may be formed by any granulation process, including compression, compaction, briquetting, pan granulation, and/or the like, as readily understood by one having minimal skill in the art. A solvent or other processing aide may be utilized and subsequently at least partially removed from the composition, e.g., by drying, to produce the solid state dispersion.

The solid state dispersion may be present in the form of extruded articles, pellets, granules, briquettes, metered doses, rods, sheets, water-soluble packets, and/or the like.

### Treatment Fluid

In an embodiment, treatment fluids, compositions and methods in various embodiments comprise the solid state dispersion according to any one or combination of embodiments disclosed herein.

In an embodiment, a treatment fluid comprises the solid state dispersion according to any one or combination of embodiments disclosed herein. In an embodiment, a method includes contacting the solid state dispersion disclosed herein with an aqueous carrier fluid at a temperature and for a period of time sufficient to dissolve and/or disperse at least a portion of the water soluble polymer to produce a treatment fluid comprising the plurality of particles of the discontinuous phase dispersed in the carrier fluid.

In some embodiments, the treatment fluid may include a continuous fluid phase, also referred to as an external phase, and a discontinuous phase(s), also referred to as an internal phase(s), which may be a fluid (liquid or gas) in the case of an emulsion, foam or energized fluid, or which may be a solid in the case of a slurry, a portion of which is provided by dissolution of the solid state dispersion. The continuous fluid phase, also referred to herein as the carrier fluid or comprising the carrier fluid, may be any matter that is substantially continuous under a given condition. Examples of the continuous fluid phase include, but are not limited to, water, hydrocarbon, gas, liquefied gas, etc., which may include solutes, e.g. the fluid phase may be a brine, and/or may include a brine or other solution(s). In some embodiments, the fluid phase(s) may optionally include a viscosifying and/or yield point agent and/or a portion of the total amount of viscosifying and/or yield point agent present. Some non-limiting examples of the fluid phase(s) include hydratable gels (e.g. gels containing polysaccharides such as guars, xanthan and diutan, hydroxyethylcellulose, polyvinyl alcohol, other hydratable polymers, colloids, etc.), a cross-linked hydratable gel, a viscosified acid (e.g. gel-based), an emulsified acid (e.g. oil outer phase), an energized fluid (e.g., an N₂ or CO₂ based foam), a viscoelastic surfactant (VES) viscosified fluid, and an oil-based fluid including a gelled, foamed, or otherwise viscosified oil, any of which may be provided by dissolution of the solid state dispersion.

The discontinuous phase if present in the treatment fluid may be any particles (including fluid droplets) that are suspended or otherwise dispersed in the continuous phase in a disjointed manner. In this respect, the discontinuous phase can also be referred to, collectively, as “particle” or “particulate” which may be used interchangeably. As used herein, the term “particle” should be construed broadly. For example, in some embodiments, the particle(s) of the current application are solid such as proppant, sands, ceramics, crystals, salts, etc.; however, in some other embodiments, the particle(s) can be liquid, gas, foam, emulsified droplets, etc. Moreover, in some embodiments, the particle(s) of the current application are substantially stable and do not change shape or form over an extended period of time, temperature, or pressure; in some other embodiments, the particle(s) of the current application are degradable, dissolvable, deformable, meltable, sublimeable, or otherwise capable of being changed in shape, state, or structure, any of which may be provided by dissolution of the solid state dispersion.

In an embodiment, the particle(s) is substantially round and spherical. In an embodiment, the particle(s) is not substantially spherical and/or round, e.g., it can have varying degrees of sphericity and roundness, according to the API RP-60 sphericity and roundness index. For example, the particle(s) may have an aspect ratio, defined as the ratio of the longest dimension of the particle to the shortest dimension of the particle, of more than 2, 3, 4, 5 or 6. Examples of such non-spherical particles include, but are not limited to, fibers, flakes, discs, rods, stars, etc. All such variations should be considered within the scope of the current application.

In an embodiment, the particles may be multimodal. As used herein multimodal refers to a plurality of particle sizes or modes which each has a distinct size or particle size distribution, e.g., proppant and fines. As used herein, the terms distinct particle sizes, distinct particle size distribution, or multi-modes or multimodal, mean that each of the plurality of particles has a unique volume-averaged particle size distribution (PSD) mode. That is, statistically, the particle size distributions of different particles appear as distinct peaks (or “modes”) in a continuous probability distribution function. For example, a mixture of two particles having normal distribution of particle sizes with similar variability is considered a bimodal particle mixture if their respective means differ by more than the sum of their respective standard deviations, and/or if their respective means differ by a statistically significant amount. In an embodiment, the particles contain a bimodal mixture of two particles; in an embodiment, the particles contain a trimodal mixture of three particles; in an embodiment, the particles contain a tetramodal mixture of four particles; in an embodiment, the particles contain a pentamodal mixture of five particles, and so on. Representative references disclosing multimodal particle mixtures include U.S. Pat. No. 5,518,996, U.S. Pat. No. 7,784,541, U.S. Pat. No. 7,789,146, U.S. Pat. No. 8,008,234, U.S. Pat. No. 8,119,574, U.S. Pat. No. 8,210,249, US 2010/0300688, US 2012/0000641, US 2012/0138296, US 2012/0132421, US 2012/0111563, WO 2012/054456, US 2012/0305245, US 2012/0305254, US 2012/0132421, PCT/RU2011/000971 and U.S. Ser. No. 13/415,025, each of which are hereby incorporated herein by reference.

“Solids” and “solids volume” refer to all solids present in the slurry, including proppant and subproppant particles, including particulate thickeners such as colloids and submicron particles. “Solids-free” and similar terms generally exclude proppant and subproppant particles, except particulate thickeners such as colloids for the purposes of determining the viscosity of a “solids-free” fluid. “Proppant” refers to particulates that are used in well work-overs and treatments, such as hydraulic fracturing operations, to hold fractures open following the treatment, of a particle size mode or modes in the slurry having a weight average mean particle size greater than or equal to about 100 microns, e.g., 140 mesh particles correspond to a size of 105 microns, unless a different proppant size is indicated in the claim or a smaller proppant size is indicated in a claim depending therefrom. “Gravel” refers to particles used in gravel packing, and the term is synonymous with proppant as used herein. “Sub-proppant” or “subproppant” refers to particles or particle size or mode (including colloidal and submicron particles) having a smaller size than the proppant mode(s); references to “proppant” exclude subproppant particles and vice versa. In an embodiment, the sub-proppant mode or modes each have a weight average mean particle size less than or equal to about one-half of the weight average mean particle size of a smallest one of the proppant modes, e.g., a suspensive/stabilizing mode.

The proppant, when present, can be naturally occurring materials, such as sand grains. The proppant, when present, can also be man-made or specially engineered, such as coated (including resin-coated) sand, modulus of various nuts, high-strength ceramic materials like sintered bauxite, etc. In some embodiments, the proppant of the current application, when present, has a density greater than 2.45 g/mL, e.g., 2.5-2.8 g/mL, such as sand, ceramic, sintered bauxite or resin coated proppant. In some embodiments, the proppant of the current application, when present, has a density less than or equal to 2.45 g/mL, such as less than about 1.60 g/mL, less than about 1.50 g/mL, less than about 1.40 g/mL, less than about 1.30 g/mL, less than about 1.20 g/mL, less than 1.10 g/mL, or less than 1.00 g/mL, such as light/ultralight proppant from various manufacturers, e.g., hollow proppant.

In some embodiments, the treatment fluid comprises an apparent specific gravity greater than 1.3, greater than 1.4, greater than 1.5, greater than 1.6, greater than 1.7, greater than 1.8, greater than 1.9, greater than 2, greater than 2.1, greater than 2.2, greater than 2.3, greater than 2.4, greater than 2.5, greater than 2.6, greater than 2.7, greater than 2.8, greater than 2.9, or greater than 3. The treatment fluid density can be selected by selecting the specific gravity and amount of the dispersed solids and/or adding a weighting solute to the aqueous phase, such as, for example, a compatible organic or mineral salt. In some embodiments, the aqueous or other liquid phase may have a specific gravity greater than 1, greater than 1.05, greater than 1.1, greater than 1.2, greater than 1.3, greater than 1.4, greater than 1.5, greater than 1.6, greater than 1.7, greater than 1.8, greater than 1.9, greater than 2, greater than 2.1, greater than 2.2, greater than 2.3, greater than 2.4, greater than 2.5, greater than 2.6, greater than 2.7, greater than 2.8, greater than 2.9, or greater than 3, etc. In some embodiments, the aqueous or other liquid phase may have a specific gravity less than 1. In an embodiment, the weight of the treatment fluid can provide additional hydrostatic head pressurization in the wellbore at the perforations or other fracture location, and can also facilitate stability by lessening the density differences between the larger solids and the whole remaining fluid. In other embodiments, a low density proppant may be used in the treatment, for example, lightweight proppant (apparent specific gravity less than 2.65) having a density less than or equal to 2.5 g/mL, such as less than about 2 g/mL, less than about 1.8 g/mL, less than about 1.6 g/mL, less than about 1.4 g/mL, less than about 1.2 g/mL, less than 1.1 g/mL, or less than 1 g/mL. In other embodiments, the proppant or other particles in the slurry may have a specific gravity greater than 2.6, greater than 2.7, greater than 2.8, greater than 2.9, greater than 3, etc.

“Stable” or “stabilized” or similar terms refer to a stabilized treatment slurry (STS) wherein gravitational settling of the particles is inhibited such that no or minimal free liquid is formed, and/or there is no or minimal rheological variation among strata at different depths in the STS, and/or the slurry may generally be regarded as stable over the duration of expected STS storage and use conditions, e.g., an STS that passes a stability test or an equivalent thereof. In an embodiment, stability can be evaluated following different settling conditions, such as for example static under gravity alone, or dynamic under a vibratory influence, or dynamic-static conditions employing at least one dynamic settling condition followed and/or preceded by at least one static settling condition.

The static settling test conditions can include gravity settling for a specified period, e.g., 24 hours, 48 hours, 72 hours, or the like, which are generally referred to with the respective shorthand notation “24 h-static”, “48 h-static” or “72 h static”. Dynamic settling test conditions generally indicate the vibratory frequency and duration, e.g., 4 h@15 Hz (4 hours at 15 Hz), 8 h@5 Hz (8 hours at 5 Hz), or the like. Dynamic settling test conditions are at a vibratory amplitude of 1 mm vertical displacement unless otherwise indicated. Dynamic-static settling test conditions will indicate the settling history preceding analysis including the total duration of vibration and the final period of static conditions, e.g., 4 h@15 Hz/20 h-static refers to 4 hours vibration followed by 20 hours static, or 8 h@15 Hz/10 d-static refers to 8 hours total vibration, e.g., 4 hours vibration followed by 20 hours static followed by 4 hours vibration, followed by 10 days of static conditions. In the absence of a contrary indication, the designation “8 h@15 Hz/10 d-static” refers to the test conditions of 4 hours vibration, followed by 20 hours static followed by 4 hours vibration, followed by 10 days of static conditions. In the absence of specified settling conditions, the settling condition is 72 hours static. The stability settling and test conditions are at 25° C. unless otherwise specified.

In an embodiment, one stability test is referred to herein as the “8 h@15 Hz/10 d-static STS stability test”, wherein a slurry sample is evaluated in a rheometer at the beginning of the test and compared against different strata of a slurry sample placed and sealed in a 152 mm (6 in.) diameter vertical gravitational settling column filled to a depth of 2.13 m (7 ft), vibrated at 15 Hz with a 1 mm amplitude (vertical displacement) two 4-hour periods the first and second settling days, and thereafter maintained in a static condition for 10 days (12 days total settling time). The 15 Hz/1 mm amplitude condition in this test is selected to correspond to surface transportation and/or storage conditions prior to the well treatment. At the end of the settling period the depth of any free water at the top of the column is measured, and samples obtained, in order from the top sampling port down to the bottom, through 25.4-mm sampling ports located on the settling column at 190 mm (6′3″), 140 mm (4′7″), 84 mm (2′9″) and 33 mm (1′1″), and rheologically evaluated for viscosity and yield stress as described above.

As used herein, a stabilized treatment slurry (STS) may meet at least one of the following conditions:
(1) the slurry has a low-shear viscosity equal to or greater than 1 Pa-s (5.11 s⁻¹, 25° C.);
(2) the slurry has a Herschel-Buckley (including Bingham plastic) yield stress (as determined in the manner described herein) equal to or greater than 1 Pa; or
(3) the largest particle mode in the slurry has a static settling rate less than 0.01 mm/hr; or
(4) the depth of any free fluid at the end of a 72-hour static settling test condition or an 8 h@15 Hz/10 d-static dynamic settling test condition (4 hours vibration followed by 20 hours static followed by 4 hours vibration followed finally by 10 days of static conditions) is no more than 2% of total depth; or
(5) the apparent dynamic viscosity (25° C., 170 s⁻¹) across column strata after the 72-hour static settling test condition or the 8 h@15 Hz/10 d-static dynamic settling test condition is no more than +/−20% of the initial dynamic viscosity; or
(6) the slurry solids volume fraction (SVF) across the column strata below any free water layer after the 72-hour static settling test condition or the 8 h@15 Hz/10 d-static dynamic settling test condition is no more than 5% greater than the initial SVF; or
(7) the density across the column strata below any free water layer after the 72-hour static settling test condition or the 8 h@15 Hz/10 d-static dynamic settling test condition is no more than 1% of the initial density.

In an embodiment, the depth of any free fluid at the end of the 8 h@15 Hz/10 d-static dynamic settling test condition is no more than 2% of total depth, the apparent dynamic viscosity (25° C., 170 s−1) across column strata after the 8 h@15 Hz/10 d-static dynamic settling test condition is no more than +/−20% of the initial dynamic viscosity, the slurry solids volume fraction (SVF) across the column strata below any free water layer after the 8 h@15 Hz/10 d-static dynamic settling test condition is no more than 5% greater than the initial SVF, and the density across the column strata below any free water layer after the 8 h@15 Hz/10 d-static dynamic settling test condition is no more than 1% of the initial density.

In some embodiments, the treatment slurry comprises at least one of the following stability indicia: (1) an SVF of at least 0.4 up to SVF=PVF; (2) a low-shear viscosity of at least 1 Pa-s (5.11 s⁻¹, 25° C.); (3) a yield stress (as determined herein) of at least 1 Pa; (4) an apparent viscosity of at least 50 mPa-s (170 s⁻¹, 25° C.); (5) a multimodal solids phase; (6) a solids phase having a PVF greater than 0.7; (7) a viscosifier selected from viscoelastic surfactants, in an amount ranging from 0.01 up to 7.2 g/L (60 ppt), and hydratable gelling agents in an amount ranging from 0.01 up to 4.8 g/L (40 ppt) based on the volume of fluid phase; (8) colloidal particles; (9) a particle-fluid density delta less than 1.6 g/mL, (e.g., particles having a specific gravity less than 2.65 g/mL, carrier fluid having a density greater than 1.05 g/mL or a combination thereof); (10) particles having an aspect ratio of at least 6; (11) ciliated or coated proppant; and (12) combinations thereof.

In some embodiments, the stabilized slurry comprises at least two of the stability indicia, such as for example, the SVF of at least 0.4 and the low-shear viscosity of at least 1 Pa-s (5.11 s⁻¹, 25° C.); and optionally one or more of the yield stress of at least 1 Pa, the apparent viscosity of at least 50 mPa-s (170 s⁻¹, 25° C.), the multimodal solids phase, the solids phase having a PVF greater than 0.7, the viscosifier, the colloidal particles, the particle-fluid density delta less than 1.6 g/mL, the particles having an aspect ratio of at least 6, the ciliated or coated proppant, or a combination thereof, any of which may be provided by dissolution of the solid state dispersion.

In some embodiments, the stabilized slurry comprises at least three of the stability indicia, such as for example, the SVF of at least 0.4, the low-shear viscosity of at least 1 Pa-s (5.11 s⁻¹, 25° C.) and the yield stress of at least 1 Pa; and optionally one or more of the apparent viscosity of at least 50 mPa-s (170 s⁻¹, 25° C.), the multimodal solids phase, the solids phase having a PVF greater than 0.7, the viscosifier, the colloidal particles, the particle-fluid density delta less than 1.6 g/mL, the particles having an aspect ratio of at least 6, the ciliated or coated proppant, or a combination thereof, any of which may be provided by dissolution of the solid state dispersion.

In some embodiments, the stabilized slurry comprises at least four of the stability indicia, such as for example, the SVF of at least 0.4, the low-shear viscosity of at least 1 Pa-s (5.11 s⁻¹, 25° C.), the yield stress of at least 1 Pa and the apparent viscosity of at least 50 mPa-s (170 s⁻¹, 25° C.); and optionally one or more of the multimodal solids phase, the solids phase having a PVF greater than 0.7, the viscosifier, colloidal particles, the particle-fluid density delta less than 1.6 g/mL, the particles having an aspect ratio of at least 6, the ciliated or coated proppant, or a combination thereof, any of which may be provided by dissolution of the solid state dispersion.

In some embodiments, the stabilized slurry comprises at least five of the stability indicia, such as for example, the SVF of at least 0.4, the low-shear viscosity of at least 1 Pa-s (5.11 s⁻¹, 25° C.), the yield stress of at least 1 Pa, the apparent viscosity of at least 50 mPa-s (170 s⁻¹, 25° C.) and the multimodal solids phase, and optionally one or more of the solids phase having a PVF greater than 0.7, the viscosifier, colloidal particles, the particle-fluid density delta less than 1.6 g/mL, the particles having an aspect ratio of at least 6, the ciliated or coated proppant, or a combination thereof, any of which may be provided by dissolution of the solid state dispersion.

In some embodiments, the stabilized slurry comprises at least six of the stability indicia, such as for example, the SVF of at least 0.4, the low-shear viscosity of at least 1 Pa-s (5.11 s⁻¹, 25° C.), the yield stress of at least 1 Pa, the apparent viscosity of at least 50 mPa-s (170 s⁻¹, 25° C.), the multimodal solids phase and the solids phase having a PVF greater than 0.7, and optionally one or more of the viscosifier, colloidal particles, the particle-fluid density delta less than 1.6 g/mL, the particles having an aspect ratio of at least 6, the ciliated or coated proppant, or a combination thereof, any of which may be provided by dissolution of the solid state dispersion.

In an embodiment, the treatment slurry is formed (stabilized) by at least one of the following slurry stabilization operations: (1) introducing sufficient particles into the slurry or treatment fluid to increase the SVF of the treatment fluid to at least 0.4; (2) increasing a low-shear viscosity of the slurry or treatment fluid to at least 1 Pa-s (5.11 s⁻¹, 25° C.); (3) increasing a yield stress of the slurry or treatment fluid to at least 1 Pa; (4) increasing apparent viscosity of the slurry or treatment fluid to at least 50 mPa-s (170 s⁻¹, 25° C.); (5) introducing a multimodal solids phase into the slurry or treatment fluid; (6) introducing a solids phase having a PVF greater than 0.7 into the slurry or treatment fluid; (7) introducing into the slurry or treatment fluid a viscosifier selected from viscoelastic surfactants, e.g., in an amount ranging from 0.01 up to 7.2 g/L (60 ppt), and hydratable gelling agents, e.g., in an amount ranging from 0.01 up to 4.8 g/L (40 ppt) based on the volume of fluid phase; (8) introducing colloidal particles into the slurry or treatment fluid; (9) reducing a particle-fluid density delta to less than 1.6 g/mL (e.g., introducing particles having a specific gravity less than 2.65 g/mL, carrier fluid having a density greater than 1.05 g/mL or a combination thereof); (10) introducing particles into the slurry or treatment fluid having an aspect ratio of at least 6; (11) introducing ciliated or coated proppant into slurry or treatment fluid; and (12) combinations thereof. The slurry stabilization operations may be separate or concurrent, e.g., introducing a single viscosifier may also increase low-shear viscosity, yield stress, apparent viscosity, etc., or alternatively or additionally with respect to a viscosifier, separate agents may be added to increase low-shear viscosity, yield stress and/or apparent viscosity.

The techniques to stabilize particle settling in various embodiments herein may use any one, or a combination of any two or three, or all of these approaches, i.e., a manipulation of particle/fluid density, carrier fluid viscosity, solids fraction, yield stress, and/or may use another approach. In an embodiment, the stabilized slurry is formed by at least two of the slurry stabilization operations, such as, for example, increasing the SVF and increasing the low-shear viscosity of the treatment fluid, and optionally one or more of increasing the yield stress, increasing the apparent viscosity, introducing the multimodal solids phase, introducing the solids phase having the PVF greater than 0.7, introducing the viscosifier, introducing the colloidal particles, reducing the particle-fluid density delta, introducing the particles having the aspect ratio of at least 6, introducing the ciliated or coated proppant or a combination thereof.

In an embodiment, the stabilized slurry is formed by at least three of the slurry stabilization operations, such as, for example, increasing the SVF, increasing the low-shear viscosity and introducing the multimodal solids phase, and optionally one or more of increasing the yield stress, increasing the apparent viscosity, introducing the solids phase having the PVF greater than 0.7, introducing the viscosifier, introducing the colloidal particles, reducing the particle-fluid density delta, introducing the particles having the aspect ratio of at least 6, introducing the ciliated or coated proppant or a combination thereof.

In an embodiment, the stabilized slurry is formed by at least four of the slurry stabilization operations, such as, for example, increasing the SVF, increasing the low-shear viscosity, increasing the yield stress and increasing apparent viscosity, and optionally one or more of introducing the multimodal solids phase, introducing the solids phase having the PVF greater than 0.7, introducing the viscosifier, introducing colloidal particles, reducing the particle-fluid density delta, introducing particles into the treatment fluid having the aspect ratio of at least 6, introducing the ciliated or coated proppant or a combination thereof.

In an embodiment, the stabilized slurry is formed by at least five of the slurry stabilization operations, such as, for example, increasing the SVF, increasing the low-shear viscosity, increasing the yield stress, increasing the apparent viscosity and introducing the multimodal solids phase, and optionally one or more of introducing the solids phase having the PVF greater than 0.7, introducing the viscosifier, introducing colloidal particles, reducing the particle-fluid density delta, introducing particles into the treatment fluid having the aspect ratio of at least 6, introducing the ciliated or coated proppant or a combination thereof.

Decreasing the density difference between the particle and the carrier fluid may be done in an embodiment by employing porous particles, including particles with an internal porosity, i.e., hollow particles. However, the porosity may also have a direct influence on the mechanical properties of the particle, e.g., the elastic modulus, which may also decrease significantly with an increase in porosity. In an embodiment employing particle porosity, care should be taken so that the crush strength of the particles exceeds the maximum expected stress for the particle, e.g., in the embodiments of proppants placed in a fracture the overburden stress of the subterranean formation in which it is to be used should not exceed the crush strength of the proppants.

In an embodiment, yield stress fluids, and also fluids having a high low-shear viscosity, are used to retard the motion of the carrier fluid and thus retard particle settling. The gravitational stress exerted by the particle at rest on the fluid beneath it must generally exceed the yield stress of the fluid to initiate fluid flow and thus settling onset. For a single particle of density 2.7 g/mL and diameter of 600 μm settling in a yield stress fluid phase of 1 g/mL, the critical fluid yield stress, i.e., the minimum yield stress to prevent settling onset, in this example is 1 Pa. The critical fluid yield stress might be higher for larger particles, including particles with size enhancement due to particle clustering, aggregation or the like.

Increasing carrier fluid viscosity in a Newtonian fluid also proportionally increases the resistance of the carrier fluid motion. In some embodiments, the fluid carrier has a lower limit of apparent dynamic viscosity, determined at 170 s⁻¹ and 25° C., of at least about 0.1 mPa-s, or at least about 1 mPa-s, or at least about 10 mPa-s, or at least about 25 mPa-s, or at least about 50 mPa-s, or at least about 75 mPa-s, or at least about 100 mPa-s, or at least about 150 mPa-s. A disadvantage of increasing the viscosity is that as the viscosity increases, the friction pressure for pumping the slurry generally increases as well. In some embodiments, the fluid carrier has an upper limit of apparent dynamic viscosity, determined at 170 s⁻¹ and 25° C., of less than about 300 mPa-s, or less than about 150 mPa-s, or less than about 100 mPa-s, or less than about 75 mPa-s, or less than about 50 mPa-s, or less than about 25 mPa-s, or less than about 10 mPa-s. In an embodiment, the fluid phase viscosity ranges from any lower limit to any higher upper limit.

In some embodiments, an agent may both viscosify and impart yield stress characteristics, and in further embodiments may also function as a friction reducer to reduce friction pressure losses in pumping the treatment fluid. In an embodiment, the liquid phase is essentially free of viscosifier or comprises a viscosifier in an amount ranging from 0.01 up to 2.4 g/L (0.08-20 lb/1000 gals) of the fluid phase. The viscosifier can be a viscoelastic surfactant (VES) or a hydratable gelling agent such as a polysaccharide, which may be crosslinked. When using viscosifiers and/or yield stress fluids, it may be useful to consider the need for and if necessary implement a clean-up procedure, i.e., removal or inactivation of the viscosifier and/or yield stress fluid during or following the treatment procedure, since fluids with viscosifiers and/or yield stresses may present clean up difficulties in some situations or if not used correctly. In an embodiment, clean up can be effected using a breaker(s). In some embodiments, the slurry is stabilized for storage and/or pumping or other use at the surface conditions, and clean-up is achieved downhole at a later time and at a higher temperature, e.g., for some formations, the temperature difference between surface and downhole can be significant and useful for triggering degradation of the viscosifier, the particles, a yield stress agent or characteristic, and/or a breaker. Thus in some embodiments, breakers that are either temperature sensitive or time sensitive, either through delayed action breakers or delay in mixing the breaker into the slurry, can be useful, any of which may be provided by dissolution of the solid state dispersion.

In an embodiment, the fluid may be stabilized by introducing colloidal particles into the treatment fluid, such as, for example, colloidal silica, which may function as a gellant and/or thickener, any of which may be provided by dissolution of the solid state dispersion.

In addition or as an alternative to increasing the viscosity of the carrier fluid (with or without density manipulation), increasing the volume fraction of the particles in the treatment fluid can also hinder movement of the carrier fluid. Where the particles are not deformable, the particles interfere with the flow of the fluid around the settling particle to cause hindered settling. The addition of a large volume fraction of particles can be complicated, however, by increasing fluid viscosity and pumping pressure, and increasing the risk of loss of fluidity of the slurry in the event of carrier fluid losses. In some embodiments, the treatment fluid has a lower limit of apparent dynamic viscosity, determined at 170 s⁻¹ and 25° C., of at least about 1 mPa-s, or at least about 10 mPa-s, or at least about 25 mPa-s, or at least about 50 mPa-s, or at least about 75 mPa-s, or at least about 100 mPa-s, or at least about 150 mPa-s, or at least about 300 mPa-s, and an upper limit of apparent dynamic viscosity, determined at 170 s⁻¹ and 25° C., of less than about 500 mPa-s, or less than about 300 mPa-s, or less than about 150 mPa-s, or less than about 100 mPa-s, or less than about 75 mPa-s, or less than about 50 mPa-s, or less than about 25 mPa-s, or less than about 10 mPa-s. In an embodiment, the treatment fluid viscosity ranges from any lower limit to any higher upper limit.

In an embodiment, the treatment fluid may be stabilized by introducing sufficient particles into the treatment fluid to increase the SVF of the treatment fluid, e.g., to at least 0.5. In a powder or particulated medium, the packed volume fraction (PVF) is defined as the volume of space occupied by the particles (the absolute volume) divided by the bulk volume, i.e., the total volume of the particles plus the void space between them:

PVF=Particle volume/(Particle volume+Non-particle Volume)=1-porosity

For the purposes of calculating PVF and slurry solids volume fraction (SVF) herein, the particle volume includes the volume of any colloidal and/or submicron particles.

Here, the porosity, φ, is the void fraction of the powder pack. Unless otherwise specified the PVF of a particulated medium is determined in the absence of overburden or other compressive force that would deform the packed solids. The packing of particles (in the absence of overburden) is a purely geometrical phenomenon. Therefore, the PVF depends only on the size and the shape of particles. The most ordered arrangement of monodisperse spheres (spheres with exactly the same size in a compact hexagonal packing) has a PVF of 0.74. However, such highly ordered arrangements of particles rarely occur in industrial operations. Rather, a somewhat random packing of particles is prevalent in oilfield treatment. Unless otherwise specified, particle packing in the current application means random packing of the particles. A random packing of the same spheres has a PVF of 0.64. In other words, the randomly packed particles occupy 64% of the bulk volume, and the void space occupies 36% of the bulk volume. A higher PVF can be achieved by preparing blends of particles that have more than one particle size and/or a range(s) of particle sizes. The smaller particles can fit in the void spaces between the larger ones.

The PVF in an embodiment can therefore be increased by using a multimodal particle mixture, for example, coarse, medium and fine particles in specific volume ratios, where the fine particles can fit in the void spaces between the medium-size particles, and the medium size particles can fit in the void space between the coarse particles. For some embodiments of two consecutive size classes or modes, the ratio between the mean particle diameters (d₅₀) of each mode may be between 7 and 10. In such cases, the PVF can increase up to 0.95 in some embodiments. By blending coarse particles (such as proppant) with other particles selected to increase the PVF, only a minimum amount of fluid phase (such as water) is needed to render the treatment fluid pumpable. Such concentrated suspensions (i.e. slurry) tend to behave as a porous solid and may shrink under the force of gravity. This is a hindered settling phenomenon as discussed above and, as mentioned, the extent of solids-like behavior generally increases with the slurry solid volume fraction (SVF), which is given as

SVF=Particle volume/(Particle volume+Liquid volume)

It follows that proppant or other large particle mode settling in multimodal embodiments can if desired be minimized independently of the viscosity of the continuous phase. Therefore, in some embodiments little or no viscosifier and/or yield stress agent, e.g., a gelling agent, is required to inhibit settling and achieve particle transport, such as, for example, less than 2.4 g/L, less than 1.2 g/L, less than 0.6 g/L, less than 0.3 g/L, less than 0.15 g/L, less than 0.08 g/L, less than 0.04 g/L, less than 0.2 g/L or less than 0.1 g/L of viscosifier may be present in the STS, any of which may be provided by dissolution of the solid state dispersion.

It is helpful for an understanding of the current application to consider the amounts of particles present in the slurries of various embodiments of the treatment fluid. The minimum amount of fluid phase necessary to make a homogeneous slurry blend is the amount required to just fill all the void space in the PVF with the continuous phase, i.e., when SVF=PVF. However, this blend may not be flowable since all the solids and liquid may be locked in place with no room for slipping and mobility. In flowable system embodiments, SVF may be lower than PVF, e.g., SVF/PVF≦0.99. In this condition, in a stabilized treatment slurry, essentially all the voids are filled with excess liquid to increase the spacing between particles so that the particles can roll or flow past each other. In some embodiments, the higher the PVF, the lower the SVF/PVF ratio should be to obtain a flowable slurry.

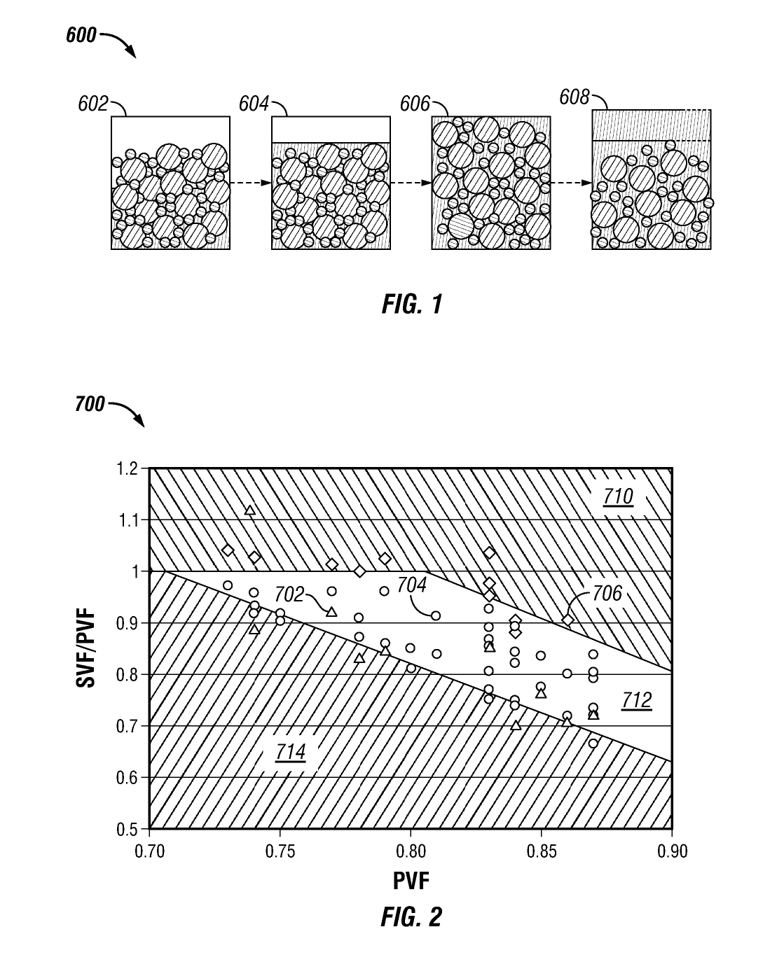

FIG. 1 shows a slurry state progression chart for a system 600 having a particle mix with added fluid phase. The first fluid 602 does not have enough liquid added to fill the pore spaces of the particles, or in other words the SVF/PVF is greater than 1.0. The first fluid 602 is not flowable. The second fluid 604 has just enough fluid phase to fill the pore spaces of the particles, or in other words the SVF/PVF is equal to 1.0. Testing determines whether the second fluid 604 is flowable and/or pumpable, but a fluid with an SVF/PVF of 1.0 is generally not flowable or barely flowable due to an excessive apparent viscosity and/or yield stress. The third fluid 606 has slightly more fluid phase than is required to fill the pore spaces of the particles, or in other words the SVF/PVF is just less than 1.0. A range of SVF/PVF values less than 1.0 will generally be flowable and/or pumpable or mixable, and if it does not contain too much fluid phase (and/or contains an added viscosifier) the third fluid 606 is stable. The values of the range of SVF/PVF values that are pumpable, flowable, mixable, and/or stable are dependent upon, without limitation, the specific particle mixture, fluid phase viscosity, the PVF of the particles, and the density of the particles. Simple laboratory testing of the sort ordinarily performed for fluids before fracturing treatments can readily determine the stability (e.g., the STS stability test as described herein) and flowability (e.g., apparent dynamic viscosity at 170 s⁻¹ and 25° C. of less than about 10,000 mPa-s).

The fourth fluid 608 shown in FIG. 1 has more fluid phase than the third fluid 606, to the point where the fourth fluid 608 is flowable but is not stabilized and settles, forming a layer of free fluid phase at the top (or bottom, depending upon the densities of the particles in the fourth fluid 608). The amount of free fluid phase and the settling time over which the free fluid phase develops before the fluid is considered unstable are parameters that depend upon the specific circumstances of a treatment, as noted above. For example, if the settling time over which the free liquid develops is greater than a planned treatment time, then in one example the fluid would be considered stable. Other factors, without limitation, that may affect whether a particular fluid remains stable include the amount of time for settling and flow regimes (e.g. laminar, turbulent, Reynolds number ranges, etc.) of the fluid flowing in a flow passage of interest or in an agitated vessel, e.g., the amount of time and flow regimes of the fluid flowing in the wellbore, fracture, etc., and/or the amount of fluid leakoff occurring in the wellbore, fracture, etc. A fluid that is stable for one fracturing treatment may be unstable for a second fracturing treatment. The determination that a fluid is stable at particular conditions may be an iterative determination based upon initial estimates and subsequent modeling results. In some embodiments, the stabilized treatment fluid passes the STS test described herein.

FIG. 2 shows a data set 700 of various essentially Newtonian fluids without any added viscosifiers and without any yield stress, which were tested for the progression of slurry state on a plot of SVF/PVF as a function of PVF. The fluid phase in the experiments was water and the solids had specific gravity 2.6 g/mL. Data points 702 indicated with a triangle were values that had free water in the slurry, data points 704 indicated with a circle were slurriable fluids that were mixable without excessive free water, and data points 706 indicated with a diamond were not easily mixable liquid-solid mixtures. The data set 700 includes fluids prepared having a number of discrete PVF values, with liquid added until the mixture transitions from not mixable to a slurriable fluid, and then further progresses to a fluid having excess settling. At an example for a solids mixture with a PVF value near PVF=0.83, it was observed that around an SVF/PVF value of 0.95 the fluid transitions from an unmixable mixture to a slurriable fluid. At around an SVF/PVF of 0.7, the fluid transitions from a stable slurry to an unstable fluid having excessive settling. It can be seen from the data set 700 that the compositions can be defined approximately into a non-mixable region 710, a slurriable region 712, and a settling region 714.

FIG. 2 shows the useful range of SVF and PVF for slurries in an embodiment without gelling agents. In some embodiments, the SVF is less than the PVF, or the ratio SVF/PVF is within the range from about 0.6 or about 0.65 to about 0.95 or about 0.98. Where the liquid phase has a viscosity less than 10 mPa-s or where the treatment fluid is water essentially free of thickeners, in some embodiments PVF is greater than 0.72 and a ratio of SVF/PVF is greater than about 1−2.1*(PVF−0.72) for stability (non-settling). Where the PVF is greater than 0.81, in some embodiments a ratio of SVF/PVF may be less than 1−2.1*(PVF−0.81) for mixability (flowability). Adding thickening or suspending agents, or solids that perform this function such as calcium carbonate or colloids, i.e., to increase viscosity and/or impart a yield stress, in some embodiments allows fluids otherwise in the settling area 714 embodiments (where SVF/PVF is less than or equal to about 1−2.1*(PVF−0.72)) to also be useful as an STS or in applications where a non-settling, slurriable/mixable slurry is beneficial, e.g., where the treatment fluid has a viscosity greater than 10 mPa-s, greater than 25 mPa-s, greater than 50 mPa-s, greater than 75 mPa-s, greater than 100 mPa-s, greater than 150 mPa-s, or greater than 300 mPa-s; and/or a yield stress greater than 0.1 Pa, greater than 0.5 Pa, greater than 1 Pa, greater than 10 Pa or greater than 20 Pa.

Introducing high-aspect ratio particles into the treatment fluid, e.g., particles having an aspect ratio of at least 6, represents additional or alternative embodiments for stabilizing the treatment fluid. Examples of such non-spherical particles include, but are not limited to, fibers, flakes, discs, rods, stars, etc., as described in, for example, U.S. Pat. No. 7,275,596, US20080196896, which are hereby incorporated herein by reference. In an embodiment, introducing ciliated or coated proppant into the treatment fluid may stabilize or help stabilize the treatment fluid, any of which may be provided by dissolution of the solid state dispersion.

Proppant or other particles coated with a hydrophilic polymer can make the particles behave like larger particles and/or more tacky particles in an aqueous medium. The hydrophilic coating on a molecular scale may resemble ciliates, i.e., proppant particles to which hairlike projections have been attached to or formed on the surfaces thereof. Herein, hydrophilically coated proppant particles are referred to as “ciliated or coated proppant.” Hydrophilically coated proppants and methods of producing them are described, for example, in WO 2011-050046, U.S. Pat. No. 5,905,468, U.S. Pat. No. 8,227,026 and U.S. Pat. No. 8,234,072, which are hereby incorporated herein by reference.

In some additional or alternative embodiment, the STS system may have the benefit that the smaller particles in the voids of the larger particles act as slip additives like mini-ball bearings, allowing the particles to roll past each other without any requirement for relatively large spaces between particles, any of which may be provided by dissolution of the solid state dispersion. This property can be demonstrated in some embodiments by the flow of the STS through a relatively small slot orifice with respect to the maximum diameter of the largest particle mode of the STS, e.g., a slot orifice less than 6 times the largest particle diameter, without bridging at the slot, i.e., the slurry flowed out of the slot has an SVF that is at least 90% of the SVF of the STS supplied to the slot. In contrast, the slickwater technique requires a ratio of perforation diameter to proppant diameter of at least 6, and additional enlargement for added safety to avoid screen out usually dictates a ratio of at least 8 or 10 and does not allow high proppant loadings.

In an embodiment, the flowability of the STS through narrow flow passages such as perforations and fractures is similarly facilitated, allowing a smaller ratio of perforation diameter and/or fracture height to proppant size that still provides transport of the proppant through the perforation and/or to the tip of the fracture, i.e., improved flowability of the proppant in the fracture, e.g., in relatively narrow fracture widths, and improved penetration of the proppant-filled fracture extending away from the wellbore into the formation. These embodiments provide a relatively longer proppant-filled fracture prior to screenout relative to slickwater or high-viscosity fluid treatments.

As used herein, the “minimum slot flow test ratio” refers to a test wherein an approximately 100 mL slurry specimen is loaded into a fluid loss cell with a bottom slot opened to allow the test slurry to come out, with the fluid pushed by a piston using water or another hydraulic fluid supplied with an ISCO pump or equivalent at a rate of 20 mL/min, wherein a slot at the bottom of the cell can be adjusted to different openings at a ratio of slot width to largest particle mode diameter less than 6, and wherein the maximum slot flow test ratio is taken as the lowest ratio observed at which 50 vol % or more of the slurry specimen flows through the slot before bridging and a pressure increase to the maximum gauge pressure occurs. In some embodiments, the STS has a minimum slot flow test ratio less than 6, or less than 5, or less than 4, or less than 3, or a range of 2 to 6, or a range of 3 to 5.

Because of the relatively low water content (high SVF) of some embodiments of the STS, fluid loss from the STS may be a concern where flowability is important and SVF should at least be held lower than PVF, or considerably lower than PVF in some other embodiments. In conventional hydraulic fracturing treatments, there are two main reasons that a high volume of fluid and high amount of pumping energy have to be used, namely proppant transport and fluid loss. To carry the proppant to a distant location in a fracture, the treatment fluid has to be sufficiently turbulent (slickwater) or viscous (gelled fluid). Even so, only a low concentration of proppant is typically included in the treatment fluid to avoid settling and/or screen out. Moreover, when a fluid is pumped into a formation to initiate or propagate a fracture, the fluid pressure will be higher than the formation pressure, and the liquid in the treatment fluid is constantly leaking off into the formation. This is especially the case for slickwater operations. The fracture creation is a balance between the fluid loss and new volume created. As used herein, “fracture creation” encompasses either or both the initiation of fractures and the propagation or growth thereof. If the liquid injection rate is lower than the fluid loss rate, the fracture cannot be grown and becomes packed off. Therefore, traditional hydraulic fracturing operations are not efficient in creating fractures in the formation.

In some embodiments of the STS herein where the SVF is high, even a small loss of carrier fluid may result in a loss of flowability of the treatment fluid, and in some embodiments it is therefore undertaken to guard against excessive fluid loss from the treatment fluid, at least until the fluid and/or proppant reaches its ultimate destination. In an embodiment, the STS may have an excellent tendency to retain fluid and thereby maintain flowability, i.e., it has a low leakoff rate into a porous or permeable surface with which it may be in contact. According to some embodiments of the current application, the treatment fluid is formulated to have very good leakoff control characteristics, i.e., fluid retention to maintain flowability. The good leak control can be achieved by including a leakoff control system in the treatment fluid of the current application, which may comprise one or more of high viscosity, low viscosity, a fluid loss control agent, selective construction of a multi-modal particle system in a multimodal fluid (MMF) or in a stabilized multimodal fluid (SMMF), or the like, or any combination thereof, any of which may be provided by dissolution of the solid state dispersion.

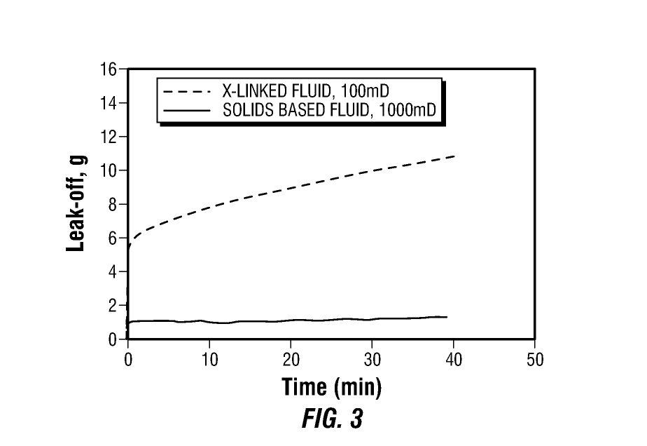

As discussed in the examples below and as shown in FIG. 3, the leakoff of embodiments of a treatment fluid of the current application was an order of magnitude less than that of a conventional crosslinked fluid. It should be noted that the leakoff characteristic of a treatment fluid is dependent on the permeability of the formation to be treated. Therefore, a treatment fluid that forms a low permeability filter cake with good leakoff characteristic for one formation may or may not be a treatment fluid with good leakoff for another formation. Conversely, in an embodiment, the treatment fluids of the current application form low permeability filter cakes that have substantially superior leakoff characteristics such that they are not dependent on the substrate permeability provided the substrate permeability is higher than a certain minimum, e.g., at least 1 mD.

In an embodiment, the STS comprises a packed volume fraction (PVF) greater than a slurry solids volume fraction (SVF), and has a spurt loss value (Vspurt) less than 10 vol % of a fluid phase of the stabilized treatment fluid or less than 50 vol % of an excess fluid phase (Vspurt<0.50*(PVF-SVF), where the “excess fluid phase” is taken as the amount of fluid in excess of the amount present at the condition SVF=PVF, i.e., excess fluid phase=PVF-SVF).

In some embodiments the treatment fluid comprises an STS also having a very low leakoff rate. For example, the total leakoff coefficient may be about 3×10⁻⁴ m/min^{1/2} (10⁻³ ft/min^{1/2}) or less, or about 3×10⁻⁵ m/min^{1/2} (10⁻⁴ ft/min^{1/2}) or less. As used herein, Vspurt and the total leak-off coefficient Cw are determined by following the static fluid loss test and procedures set forth in Section 8-8.1, “Fluid loss under static conditions,” in Reservoir Stimulation, 3rd Edition, Schlumberger, John Wiley & Sons, Ltd., pp. 8-23 to 8-24, 2000, in a filter-press cell using ceramic disks (FANN filter disks, part number 210538) saturated with 2% KC solution and covered with filter paper and test conditions of ambient temperature (25° C.), a differential pressure of 3.45 MPa (500 psi), 100 ml sample loading, and a loss collection period of 60 minutes, or an equivalent testing procedure. In some embodiments of the current application, the treatment fluid has a fluid loss value of less than 10 g in 30 min when tested on a core sample with 1000 mD porosity. In some embodiments of the current application, the treatment fluid has a fluid loss value of less than 8 g in 30 min when tested on a core sample with 1000 mD porosity. In some embodiments of the current application, the treatment fluid has a fluid loss value of less than 6 g in 30 min when tested on a core sample with 1000 mD porosity. In some embodiments of the current application, the treatment fluid has a fluid loss value of less than 2 g in 30 min when tested on a core sample with 1000 mD porosity.

The unique low to no fluid loss property allows the treatment fluid to be pumped at a low rate or pumping stopped (static) with a low risk of screen out. In an embodiment, the low fluid loss characteristic may be obtained by including a leak-off control agent, such as, for example, particulated loss control agents (in some embodiments less than 1 micron or 0.05-0.5 microns), graded PSD or multimodal particles, polymers, latex, fiber, etc. As used herein, the terms leak-off control agent, fluid loss control agent and similar refer to additives that inhibit fluid loss from the slurry into a permeable formation.

As representative leakoff control agents which may be provided by dissolution of the solid state dispersion, which may be used alone or in a multimodal fluid, there may be mentioned latex dispersions, water soluble polymers, submicron particulates, particulates with an aspect ratio higher than 1, or higher than 6, combinations thereof and the like, such as, for example, crosslinked polyvinyl alcohol microgel. The fluid loss agent can be, for example, a latex dispersion of polyvinylidene chloride, polyvinyl acetate, polystyrene-co-butadiene; a water soluble polymer such as hydroxyethylcellulose (HEC), guar, copolymers of polyacrylamide and their derivatives; particulate fluid loss control agents in the size range of 30 nm to 1 micron, such as γ-alumina, colloidal silica, CaCO₃, SiO₂, bentonite etc.; particulates with different shapes such as glass fibers, flakes, films; and any combination thereof or the like. Fluid loss agents can if desired also include or be used in combination with acrylamido-methyl-propane sulfonate polymer (AMPS). In an embodiment, the leak-off control agent comprises a reactive solid, e.g., a hydrolyzable material such as PGA, PLA or the like; or it can include a soluble or solubilizable material such as a wax, an oil-soluble resin, or another material soluble in hydrocarbons, or calcium carbonate or another material soluble at low pH; and so on. In an embodiment, the leak-off control agent comprises a reactive solid selected from ground quartz, oil soluble resin, degradable rock salt, clay, zeolite or the like. In other embodiments, the leak-off control agent comprises one or more of magnesium hydroxide, magnesium carbonate, magnesium calcium carbonate, calcium carbonate, aluminum hydroxide, calcium oxalate, calcium phosphate, aluminum metaphosphate, sodium zinc potassium polyphosphate glass, and sodium calcium magnesium polyphosphate glass, or the like.

The solid state dispersion, and therefore the treatment fluid may additionally or alternatively include, without limitation, friction reducers, clay stabilizers, biocides, crosslinkers, breakers, corrosion inhibitors, and/or proppant flowback control additives. The treatment fluid may further include a product formed from degradation, hydrolysis, hydration, chemical reaction, or other process that occur during preparation or operation.

In an embodiment, the STS may be prepared by combining the particles, such as proppant if present and subproppant, the carrier liquid and any additives to form a proppant-containing treatment fluid, any of which may be provided by dissolution of the solid state dispersion; and stabilizing the proppant-containing treatment fluid. The combination and stabilization may occur in any order or concurrently in single or multiple stages in a batch, semi-batch or continuous operation. For example, in some embodiments, the base fluid may be prepared from the subproppant particles, the carrier liquid and other additives, and then the base fluid combined with the proppant.

The treatment fluid may be prepared on location, e.g., at the wellsite when and as needed using conventional treatment fluid blending equipment.

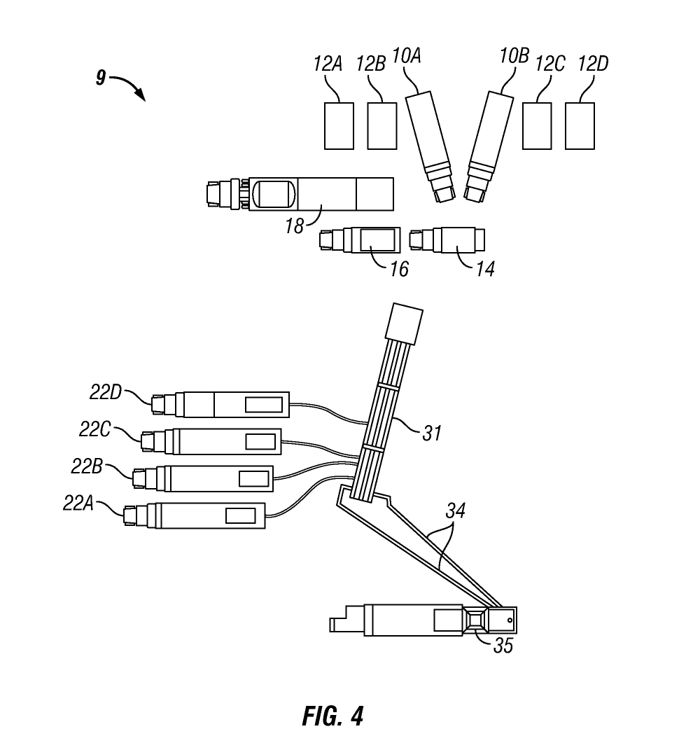

FIG. 4 shows a wellsite equipment configuration 10 for a fracture treatment job according to some embodiments using the principles disclosed herein, for a land-based fracturing operation. The proppant is contained in sand trailers 11A, 11B. Water tanks 12A, 12B, 12C, 12D are arranged along one side of the operation site. Hopper 14 receives sand from the sand trailers 10A, 10B and distributes it into the mixer truck 16. Blender 18 is provided to blend the carrier medium (such as brine, viscosified fluids, etc.) with the proppant, i.e., “on the fly,” and then the slurry is discharged to manifold 20. The final mixed and blended slurry, also called frac fluid, is then transferred to the pump trucks 22A, 22B, 22C, 22D, and routed at treatment pressure through treating line 24 to rig 26, and then pumped downhole. This configuration eliminates the additional mixer truck(s), pump trucks, blender(s), manifold(s) and line(s) normally required for slickwater fracturing operations, and the overall footprint is considerably reduced.

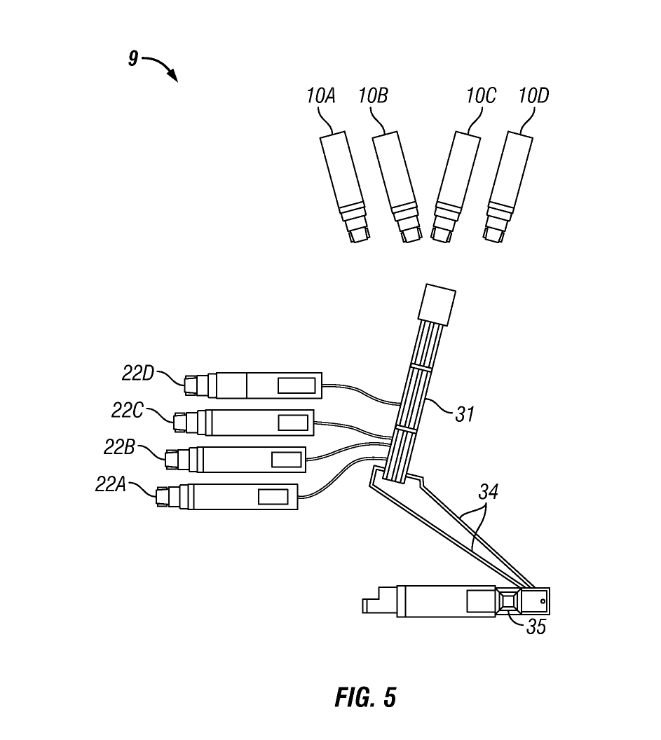

FIG. 5 shows further embodiments of the wellsite equipment configuration with the additional feature of delivery of pump-ready treatment fluid delivered to the wellsite in trailers 10A to 10D and further elimination of the mixer 26, hopper 14, and/or blender 18. In some embodiments the treatment fluid is prepared offsite and pre-mixed with proppant and other additives, or with some or all of the additives except proppant, such as in a system described in co-pending co-assigned patent applications with application Ser. No. 13/415,025, filed on Mar. 8, 2012, and application Ser. No. 13/487,002, filed on Jun. 1, 2012, the entire contents of which are incorporated herein by reference in their entireties. As used herein, the term “pump-ready” should be understood broadly. In an embodiment, a pump-ready treatment fluid means the treatment fluid is fully prepared and can be pumped downhole without being further processed. In some other embodiments, the pump-ready treatment fluid means the fluid is substantially ready to be pumped downhole except that a further dilution may be needed before pumping or one or more minor additives need to be added before the fluid is pumped downhole. In such an event, the pump-ready treatment fluid may also be called a pump-ready treatment fluid precursor. In some further embodiments, the pump-ready treatment fluid may be a fluid that is substantially ready to be pumped downhole except that certain incidental procedures are applied to the treatment fluid before pumping, such as low-speed agitation, heating or cooling under exceptionally cold or hot climate, etc.

In an embodiment herein, for example in gravel packing, fracturing and frac-and-pack operations, the STS comprises proppant and a fluid phase at a volumetric ratio of the fluid phase (Vfluid) to the proppant (Vprop) equal to or less than 3. In an embodiment, Vfluid/Vprop is equal to or less than 2.5. In an embodiment, Vfluid/Vprop is equal to or less than 2. In an embodiment, Vfluid/Vprop is equal to or less than 1.5. In an embodiment, Vfluid/Vprop is equal to or less than 1.25. In an embodiment, Vfluid/Vprop is equal to or less than 1. In an embodiment, Vfluid/Vprop is equal to or less than 0.75. In an embodiment, Vfluid/Vprop is equal to or less than 0.7. In an embodiment, Vfluid/Vprop is equal to or less than 0.6. In an embodiment, Vfluid/Vprop is equal to or less than 0.5. In an embodiment, Vfluid/Vprop is equal to or less than 0.4. In an embodiment, Vfluid/Vprop is equal to or less than 0.35. In an embodiment, Vfluid/Vprop is equal to or less than 0.3. In an embodiment, Vfluid/Vprop is equal to or less than 0.25. In an embodiment, Vfluid/Vprop is equal to or less than 0.2. In an embodiment, Vfluid/Vprop is equal to or less than 0.1. In an embodiment, Vfluid/Vprop may be sufficiently high such that the STS is flowable. In some embodiments, the ratio V_{fluid}/Vₚᵣₒₚ is equal to or greater than 0.05, equal to or greater than 0.1, equal to or greater than 0.15, equal to or greater than 0.2, equal to or greater than 0.25, equal to or greater than 0.3, equal to or greater than 0.35, equal to or greater than 0.4, equal to or greater than 0.5, or equal to or greater than 0.6, or within a range from any lower limit to any higher upper limit mentioned above.

Nota bene, the STS may optionally comprise subproppant particles in the whole fluid which are not reflected in the Vfluid/Vprop ratio, which is merely a ratio of the liquid phase (sans solids) volume to the proppant volume. This ratio is useful, in the context of the STS where the liquid phase is aqueous, as the ratio of water to proppant, i.e., Vwater/Vprop. In contrast, the “ppa” designation refers to pounds proppant added per gallon of base fluid (liquid plus subproppant particles), which can be converted to an equivalent volume of proppant added per volume of base fluid if the specific gravity of the proppant is known, e.g., 2.65 in the case of quartz sand embodiments, in which case 1 ppa=0.12 kg/L=45 mL/L; whereas “ppg” (pounds of proppant per gallon of treatment fluid) and “ppt” (pounds of additive per thousand gallons of treatment fluid) are based on the volume of the treatment fluid (liquid plus proppant and subproppant particles), which for quartz sand embodiments (specific gravity=2.65) also convert to 1 ppg=1000 ppt=0.12 kg/L=45 mL/L. The ppa, ppg and ppt nomenclature and their metric or SI equivalents are useful for considering the weight ratios of proppant or other additive(s) to base fluid (water or other fluid and subproppant) and/or to treatment fluid (water or other fluid plus proppant plus subproppant). The ppt nomenclature is generally used in an embodiment reference to the concentration by weight of low concentration additives other than proppant, e.g., 1 ppt=0.12 g/L.

In an embodiment, the proppant-containing treatment fluid comprises 0.27 L or more of proppant volume per liter of treatment fluid (corresponding to 720 g/L (6 ppg) in an embodiment where the proppant has a specific gravity of 2.65), or 0.36 L or more of proppant volume per liter of treatment fluid (corresponding to 960 g/L (8 ppg) in an embodiment where the proppant has a specific gravity of 2.65), or 0.4 L or more of proppant volume per liter of treatment fluid (corresponding to 1.08 kg/L (9 ppg) in an embodiment where the proppant has a specific gravity of 2.65), or 0.44 L or more of proppant volume per liter of treatment fluid (corresponding to 1.2 kg/L (10 ppg) in an embodiment where the proppant has a specific gravity of 2.65), or 0.53 L or more of proppant volume per liter of treatment fluid (corresponding to 1.44 kg/L (12 ppg) in an embodiment where the proppant has a specific gravity of 2.65), or 0.58 L or more of proppant volume per liter of treatment fluid (corresponding to 1.56 kg/L (13 ppg) in an embodiment where the proppant has a specific gravity of 2.65), or 0.62 L or more of proppant volume per liter of treatment fluid (corresponding to 1.68 kg/L (14 ppg) in an embodiment where the proppant has a specific gravity of 2.65), or 0.67 L or more of proppant volume per liter of treatment fluid (corresponding to 1.8 kg/L (15 ppg) in an embodiment where the proppant has a specific gravity of 2.65), or 0.71 L or more of proppant volume per liter of treatment fluid (corresponding to 1.92 kg/L (16 ppg) in an embodiment where the proppant has a specific gravity of 2.65).

As used herein, in some embodiments, “high proppant loading” means, on a mass basis, more than 1.0 kg proppant added per liter of whole fluid including any sub-proppant particles (8 ppa), or on a volumetric basis, more than 0.36 L proppant added per liter of whole fluid including any sub-proppant particles, or a combination thereof. In some embodiments, the treatment fluid comprises more than 1.1 kg proppant added per liter of whole fluid including any sub-proppant particles (9 ppa), or more than 1.2 kg proppant added per liter of whole fluid including any sub-proppant particles (10 ppa), or more than 1.44 kg proppant added per liter of whole fluid including any sub-proppant particles (12 ppa), or more than 1.68 kg proppant added per liter of whole fluid including any sub-proppant particles (14 ppa), or more than 1.92 kg proppant added per liter of whole fluid including any sub-proppant particles (16 ppa), or more than 2.4 kg proppant added per liter of fluid including any sub-proppant particles (20 ppa), or more than 2.9 kg proppant added per liter of fluid including any sub-proppant particles (24 ppa). In some embodiments, the treatment fluid comprises more than 0.45 L proppant added per liter of whole fluid including any sub-proppant particles, or more than 0.54 L proppant added per liter of whole fluid including any sub-proppant particles, or more than 0.63 L proppant added per liter of whole fluid including any sub-proppant particles, or more than 0.72 L proppant added per liter of whole fluid including any sub-proppant particles, or more than 0.9 L proppant added per liter of whole fluid including any sub-proppant particles.

In some embodiments, the water content in the fracture treatment fluid formulation is low, e.g., less than 30% by volume of the treatment fluid, the low water content enables low overall water volume to be used, relative to a slickwater fracture job for example, to place a similar amount of proppant or other solids, with low to essentially zero fluid infiltration into the formation matrix and/or with low to zero flowback after the treatment, and less chance for fluid to enter the aquifers and other intervals. The low flowback leads to less delay in producing the stimulated formation, which can be placed into production with a shortened clean up stage or in some cases immediately without a separate flowback recovery operation.

In an embodiment where the fracturing treatment fluid also has a low viscosity and a relatively high SVF, e.g., 40, 50, 60 or 70% or more, the fluid can in some surprising embodiments be very flowable (low viscosity) and can be pumped using standard well treatment equipment. With a high volumetric ratio of proppant to water, e.g., greater than about 1.0, these embodiments represent a breakthrough in water efficiency in fracture treatments. Embodiments of a low water content in the treatment fluid certainly results in correspondingly low fluid volumes to infiltrate the formation, and importantly, no or minimal flowback during fracture cleanup and when placed in production. In the solid pack, as well as on formation surfaces and in the formation matrix, water can be retained due to a capillary and/or surface wetting effect. In an embodiment, the solids pack obtained from an STS with multimodal solids can retain a larger proportion of water than conventional proppant packs, further reducing the amount of water flowback. In some embodiments, the water retention capability of the fracture-formation system can match or exceed the amount of water injected into the formation, and there may thus be no or very little water flowback when the well is placed in production.

In some specific embodiments, the proppant laden treatment fluid comprises an excess of a low viscosity continuous fluid phase, e.g., a liquid phase, and a multimodal particle phase, e.g. solids phase, comprising high proppant loading with one or more proppant modes for fracture conductivity and at least one sub-proppant mode to facilitate proppant injection. As used herein an excess of the continuous fluid phase implies that the fluid volume fraction in a slurry (1-SVF) exceeds the void volume fraction (1-PVF) of the solids in the slurry, i.e., SVF<PVF. Solids in the slurry in an embodiment may comprise both proppant and one or more sub-proppant particle modes. In an embodiment, the continuous fluid phase is a liquid phase.

In some embodiments, the STS is prepared by combining the proppant and a fluid phase having a viscosity less than 300 mPa-s (170 s⁻¹, 25 C) to form the proppant-containing treatment fluid, and stabilizing the proppant-containing treatment fluid. Stabilizing the treatment fluid is described above. In some embodiments, the proppant-containing treatment fluid is prepared to comprise a viscosity between 0.1 and 300 mPa-s (170 s⁻¹, 25 C) and a yield stress between 1 and 20 Pa (2.1-42 lb_{f}/ft²). In some embodiments, the proppant-containing treatment fluid comprises 0.36 L or more of proppant volume per liter of proppant-containing treatment fluid (8 ppa proppant equivalent where the proppant has a specific gravity of 2.6), a viscosity between 0.1 and 300 mPa-s (170 s⁻¹, 25 C), a solids phase having a packed volume fraction (PVF) greater than 0.72, a slurry solids volume fraction (SVF) less than the PVF and a ratio of SVF/PVF greater than about 1−2.1*(PVF−0.72).

In some embodiments, e.g., for delivery of a fracturing stage, the STS comprises a volumetric proppant/treatment fluid ratio (including proppant and sub-proppant solids) in a main stage of at least 0.27 L/L (6 ppg at sp.gr. 2.65), or at least 0.36 L/L (8 ppg), or at least 0.44 L/L (10 ppg), or at least 0.53 L/L (12 ppg), or at least 0.58 L/L (13 ppg), or at least 0.62 L/L (14 ppg), or at least 0.67 L/L (15 ppg), or at least 0.71 L/L (16 ppg).

In some embodiments, the hydraulic fracture treatment may comprise an overall volumetric proppant/water ratio of at least 0.13 L/L (3 ppg at sp. gr. 2.65), or at least 0.18 L/L (4 ppg), or at least 0.22 L/L (5 ppg), or at least 0.26 L/L (6 ppg), or at least 0.38 L/L (8 ppg), or at least 0.44 L/L (10 ppg), or at least 0.53 L/L (12 ppg), or at least 0.58 L/L (13 ppg). Note that subproppant particles are not a factor in the determination of the proppant water ratio.

In some embodiments, e.g., a front-end stage STS, the slurry comprises a stabilized solids mixture comprising a particulated leakoff control system (which may include solid and/or liquid particles, e.g., submicron particles, colloids, micelles, PLA dispersions, latex systems, etc.) and a solids volume fraction (SVF) of at least 0.4.

In some embodiments, e.g., a pad stage STS, the slurry comprises viscosifier in an amount to provide a viscosity in the pad stage of greater than 300 mPa-s, determined on a whole fluid basis at 170 s⁻¹ and 25° C.

In some embodiments, e.g., a flush stage STS, the slurry comprises a proppant-free slurry comprising a stabilized solids mixture comprising a particulated leakoff control system (which may include solid and/or liquid particles, e.g., submicron particles, colloids, micelles, PLA dispersions, latex systems, etc.) and a solids volume fraction (SVF) of at least 0.4. In other embodiments, the proppant-containing fracturing stage may be used with a flush stage comprising a first substage comprising viscosifier and a second substage comprising slickwater. The viscosifier may be selected from viscoelastic surfactant systems, hydratable gelling agents (optionally including crosslinked gelling agents), and the like. In other embodiments, the flush stage comprises an overflush equal to or less than 3200 L (20 42-gal bbls), equal to or less than 2400 L (15 bbls), or equal to or less than 1900 L (12 bbls).

In some embodiments, the proppant stage comprises a continuous single injection of the STS free of spacers.

In some embodiments the STS comprises a total proppant volume injected into the wellbore or to be injected into the wellbore of at least 800 liters. In some embodiments, the total proppant volume is at least 1600 liters. In some embodiments, the total proppant volume is at least

In some embodiments, the total proppant volume is at least 80,000 liters. In some embodiments, the total proppant volume is at least 800,000 liters. The total proppant volume injected into the wellbore or to be injected into the wellbore is typically not more than 16 million liters.

Sometimes it is desirable to stop pumping a treatment fluid during a hydraulic fracturing operation, such as for example, when an emergency shutdown is required. For example, there may be a complete failure of surface equipment, there may be a near wellbore screenout, or there may be a natural disaster due to weather, fire, earthquake, etc. However, with unstabilized fracturing fluids such as slickwater, the proppant suspension will be inadequate at zero pumping rate, and proppant may screen out in the wellbore and/or fail to get placed in the fracture. With slickwater it is usually impossible to resume the fracturing operation without first cleaning the settled proppant out of the wellbore, often using coiled tubing or a workover rig. There is some inefficiency in fluidizing proppant out of the wellbore with coiled tubing, and a significant amount of a specialized clean out fluid will be used to entrain the proppant and lift it to surface. After the clean out, a decision will need to be made whether to repeat the treatment or just leave that portion of the wellbore sub-optimally treated. In contrast, in an embodiment herein, the treatment fluid is stabilized and the operator can decide to resume and/or complete the fracture operation, or to circulate the STS (and any proppant) out of the well bore. By stabilizing the treatment fluid to practically eliminate particle settling, the treatment fluid possesses the characteristics of excellent proppant conveyance and transport even when static.

Due to the stability of the treatment fluid in some embodiments herein, the proppant will remain suspended and the fluid will retain its fracturing properties during the time the pumping is interrupted. In some embodiments herein, a method comprises combining at least 0.36, at least 0.4, or at least 0.45 L of proppant per liter of base fluid to form a proppant-containing treatment fluid, stabilizing the proppant-containing treatment fluid, pumping the STS, e.g., injecting the proppant-containing treatment fluid into a subterranean formation and/or creating a fracture in the subterranean formation with the treatment fluid, stopping pumping of the STS thereby stranding the treatment fluid in the wellbore, and thereafter resuming pumping of the treatment fluid, e.g., to inject the stranded treatment fluid into the formation and continue the fracture creation, and/or to circulate the stranded treatment fluid out of the wellbore as an intact plug with a managed interface between the stranded treatment fluid and a displacing fluid. Circulating the treatment fluid out of the wellbore can be achieved optionally using coiled tubing or a workover rig, if desired, but in an embodiment the treatment fluid will itself suspend and convey all the proppant out of the wellbore with high efficiency. In some embodiments, the method may include managing the interface between the treatment fluid and any displacing fluid, such as, for example, matching density and viscosity between the treatment and displacing fluids, using a wiper plug or pig, using a gelled pill or fiber pill or the like, to prevent density and viscous instabilities.

In some embodiments, the treatment provides production-related features resulting from a low water content in the treatment fluid, such as, for example, less infiltration into the formation and/or less water flowback. Formation damage occurs whenever the native reservoir conditions are disturbed. A significant source of formation damage during hydraulic fracturing occurs when the fracturing fluids contact and infiltrate the formation. Measures can be taken to reduce the potential for formation damage, including adding salts to improve the stability of fines and clays in the formation, addition of scale inhibitors to limit the precipitation of mineral scales caused by mixing of incompatible brines, addition of surfactants to minimize capillary blocking of the tight pores and so forth. There are some types of formation damage for which additives are not yet available to solve. For example, some formations will be mechanically weakened upon coming in contact with water, referred to herein as water-sensitive formations. Thus, it is desirable to significantly reduce the amount of water that can infiltrate the formation during a well completion operation.

Very low water slurries and water free slurries according to an embodiment disclosed herein offer a pathway to significantly reduce water infiltration and the collateral formation damage that may occur. Low water STS minimizes water infiltration relative to slick water fracture treatments by two mechanisms. First, the water content in the STS can be less than about 40% of slickwater per volume of respective treatment fluid, and the STS can provide in some embodiments more than a 90% reduction in the amount of water used per volume or weight of proppant placed in the formation. Second, the solids pack in the STS in an embodiment including subproppant particles retains more water than conventional proppant packs so that less water is released from the STS into the formation.

After fracturing, water flowback plagues the prior art fracturing operations. Load water recovery typically characterizes the initial phase of well start up following a completion operation. In the case of horizontal wells with massive hydraulic fractures in unconventional reservoirs, 15 to 30% of the injected hydraulic fracturing fluid is recovered during this start up phase. At some point, the load water recovery rate becomes very low and the produced gas rate high enough for the well to be directed to a gas pipeline to market. We refer to this period of time during load water recovery as the fracture clean up phase. It is normal for a well to clean up for several days before being connected to a gas sales pipeline. The flowback water must be treated and/or disposed of, and delays pipeline production. A low water content slurry according to embodiments herein can significantly reduce the volume and/or duration, or even eliminate this fracture clean up phase. Fracturing fluids normally are lost into the formation by various mechanisms including filtration into the matrix, imbibition into the matrix, wetting the freshly exposed new fracture face, loss into natural fractures. A low water content slurry will become dry with only a small loss of its water into the formation by these mechanisms, leaving in some embodiments no or very little free water to be required (or able) to flow back during the fracture clean up stage. The advantages of zero or reduced flowback include reduced operational cost to manage flowback fluid volumes, reduced water treatment cost, reduced time to put well to gas sales, reduction of problematic waste that will develop by injected waters solubilizing metals, naturally occurring radioactive materials, etc.

There have also been concerns expressed by the general public that hydraulic fracturing fluid may find some pathway into a potable aquifer and contaminate it. Although proper well engineering and completion design, and fracture treatment execution will prevent any such contamination from occurring, if it were to happen by an unforeseen accident, a slickwater system will have enough water and mobility in an aquifer to migrate similar to a salt water plume. A low water STS in an embodiment may have a 90% reduction in available water per mass of proppant such that any contact with an aquifer, should it occur, will have much less impact than slickwater.

Subterranean formations are heterogeneous, with layers of high, medium, and low permeability strata interlaced. A hydraulic fracture that grows to the extent that it encounters a high permeability zone will suddenly experience a high leakoff area that will attract a disproportionately large fraction of the injected fluid significantly changing the geometry of the created hydraulic fracture possibly in an undesirable manner. A hydraulic fracturing fluid that would automatically plug a high leakoff zone is useful in that it would make the fracture execution phase more reliable and probably ensure the fracture geometry more closely resembles the designed geometry (and thus production will be closer to that expected). One feature of embodiments of an STS is that it will dehydrate and become an immobile mass (plug) upon losing more than 25% of the water it is formulated with. As an STS in an embodiment only contains up to 50% water by volume, then it will only require a loss of a total of 12.5% of the STS treatment fluid volume in the high fluid loss affected area to become an immobile plug and prevent subsequent fluid loss from that area; or in other embodiments only contains up to 40% water by volume, requiring a loss of a total of 10% of the STS treatment fluid volume to become immobile. A slick water system would need to lose around 90% or 95% of its total volume to dehydrate the proppant into an immobile mass.

Sometimes, during a hydraulic fracture treatment, the surface treating pressure will approach the maximum pressure limit for safe operation. The maximum pressure limit may be due to the safe pressure limitation of the wellhead, the surface treating lines, the casing, or some combination of these items. One common response to reaching an upper pressure limit is to reduce the pumping rate. However, with ordinary fracturing fluids, the proppant suspension will be inadequate at low pumping rates, and proppant may fail to get placed in the fracture. The stabilized fluids in some embodiments of this disclosure, which can be highly stabilized and practically eliminate particle settling, possess the characteristic of excellent proppant conveyance and transport even when static. Thus, some risk of treatment failure is mitigated since a fracture treatment can be pumped to completion in some embodiments herein, even at very low pump rates should injection rate reduction be necessary to stay below the maximum safe operating pressure during a fracture treatment with the stabilized treatment fluid.

In some embodiments, the injection of the treatment fluid of the current application can be stopped all together (i.e. at an injection rate of 0 bbl/min). Due to the excellent stability of the treatment fluid, very little or no proppant settling occurs during the period of 0 bbl/min injection. Well intervention, treatment monitoring, equipment adjustment, etc. can be carried out by the operator during this period of time. The pumping can be resumed thereafter. Accordingly, in some embodiments of the current application, there is provided a method comprising injecting a proppant laden treatment fluid into a subterranean formation penetrated by a wellbore, initiating or propagating a fracture in the subterranean formation with the treatment fluid, stopping injecting the treatment fluid for a period of time, restarting injecting the treatment fluid to continue the initiating or propagating of the fracture in the subterranean formation.

In some embodiments, the treatment and system may achieve the ability to fracture using a carbon dioxide proppant stage treatment fluid. Carbon dioxide is normally too light and too thin (low viscosity) to carry proppant in a slurry useful in fracturing operations. However, in an STS fluid, carbon dioxide may be useful in the liquid phase, especially where the proppant stage treatment fluid also comprises a particulated fluid loss control agent. In an embodiment, the liquid phase comprises at least 10 wt % carbon dioxide, at least 50 wt % carbon dioxide, at least 60 wt % carbon dioxide, at least 70 wt % carbon dioxide, at least 80 wt % carbon dioxide, at least 90 wt % carbon dioxide, or at least 95 wt % carbon dioxide. The carbon dioxide-containing liquid phase may alternatively or additionally be present in any pre-pad stage, pad stage, front-end stage, flush stage, post-flush stage, or any combination thereof.

Various jetting and jet cutting operations in an embodiment are significantly improved by the non-settling and solids carrying abilities of the STS. Jet perforating and jet slotting are embodiments for the STS, wherein the proppant is replaced with an abrasive or erosive particle. Multi-zone fracturing systems using a locating sleeve/polished bore and jet cut opening are embodiments.

Drilling cuttings transport and cuttings stability during tripping are also improved in an embodiment. The STS can act to either fracture the formation or bridge off cracks, depending on the exact mixture used. The STS can provide an extreme ability to limit fluid losses to the formation, a very significant advantage. Minimizing the amount of liquid will make oil based muds much more economically attractive.

The modification of producing formations using explosives and/or propellant devices in an embodiment is improved by the ability of the STS to move after standing stationary and also by its density and stability.

Zonal isolations operations in an embodiment are improved by specific STS formulations optimized for leakoff control and/or bridging abilities. Relatively small quantities of the STS radically improve the sealing ability of mechanical and inflatable packers by filling and bridging off gaps. Permanent isolation of zones is achieved in some embodiments by bullheading low permeability versions of the STS into water producing formations or other formations desired to be isolated. Isolation in some embodiments is improved by using a setting formulation of the STS, but non-setting formulations can provide very effective permanent isolation. Temporary isolation may be delivered in an embodiment by using degradable materials to convert a non-permeable pack into a permeable pack after a period of time.

The pressure containing ability and ease of placement/removal of sand plugs in an embodiment are significantly improved using appropriate STS formulations selected for high bridging capacity. Such formulations will allow much larger gaps between the sand packer tool and the well bore for the same pressure capability. Another major advantage is the reversibility of dehydration in some embodiments; a solid sand pack may be readily re-fluidized and circulated out, unlike conventional sand plugs.

In other embodiments, plug and abandon work may be improved using CRETE cementing formulations in the STS and also by placing bridging/leakoff controlling STS formulations below and/or above cement plugs to provide a seal repairing material. The ability of the STS to re-fluidize after long periods of immobilization facilitates this embodiment. CRETE cementing formulations are disclosed in U.S. Pat. No. 6,626,991, GB 2,277,927, U.S. Pat. No. 6,874,578, WO 2009/046980, Schlumberger CemCRETE Brochure (2003), and Schlumberger Cementing Services and Products—Materials, pp. 39-76 (2012), available at http://www.slb.com/˜/media/Files/cementing/catalogs/05_cementing_materials.pdf which are hereby incorporated herein by reference, and are commercially available from Schlumberger.

This STS in other embodiments finds application in pipeline cleaning to remove methane hydrates due to its carrying capacity and its ability to resume motion.

Accordingly, the present disclosure provides the following embodiments:
1. A composition comprising a solid state dispersion comprising a plurality of particles dispersed in a matrix comprising a water soluble polymer.
2. The composition according to embodiment 1, wherein the plurality of particles comprise a hydrolyzable polymer.
3. The composition according to embodiments 1 or embodiment 2, wherein the particles comprise a hydrolyzable polymer, and the hydrolyzable polymer is immiscible with the water soluble polymer.
4. The composition according to any one of embodiments 1 to 3, wherein the hydrolyzable polymer is acid labile.
5. The composition according to any one of embodiments 1 to 4, further comprising particles comprising silicates, γ-alumina, MgO, γ-Fe₂O₃, TiO₂, and combinations thereof.
6. The composition according to any one of embodiments 1 to 5, wherein the plurality of particles comprises polyester.
7. The composition according to any one of embodiments 1 to 6 wherein the plurality of particles comprise polylactic acid, polyglycolic acid, polycarprolactone, polybutylene succinate, polybutylene succinate-co-adipate, polyhydroxyalkanoate polymers, or a combination thereof.
8. The composition according to any one of embodiments 1 to 7, wherein the water soluble polymer comprises polyvinyl alcohol, polyethylene oxide, sulfonated polyester, polyacrylic ester/acrylic acid copolymer, polyacrylic ester/methacrylic acid copolymer, polyethylene glycol, poly (vinyl pyrrolidone), polylactide-co-glycolide, ethyl cellulose, hydroxypropylcellulose, hydroxypropylmethylcellulose, aminomethacrylatecolpolymer, polydimethlyaminoethylmethacrylate-co-methacrylicester, polymethacyrlicacid-co-methylmethacrylate, guar, hydroxyethylcellulose, xanthan, or a combination thereof.
9. The composition according to any one of embodiments 1 to 8, wherein at least some of the plurality of particles comprise an average particle size from about 0.001 microns to about 20 microns.
10. The composition according to any one of embodiments 1 to 9, comprising from about 1 wt % to 90 wt % of the plurality of particles, based on the total weight of the composition.
11. The composition according to any one of embodiments 1 to 10, further comprising from about 0.1 wt % to about 50 wt % of a dispersant, a surfactant, a viscosifier, a defoamer, a plasticizer, or a combination thereof, based on the total weight of the composition.
12. The composition according to any one of embodiments 1 to 11, wherein the plurality of particles comprise an Apollonianistic mixture of particles comprising first and second particle size distribution modes wherein the first particle size distribution mode is from 1.5 to 25 times larger than the second particle size distribution mode.
13. The composition according to any one of embodiments 1 to 12, wherein the solid state dispersion is a melt extrudate.
14. A method comprising: contacting a solid state dispersion comprising a plurality of particles dispersed in a matrix comprising a water soluble polymer, with an aqueous carrier fluid at a temperature and for a period of time sufficient to dissolve at least a portion of the water soluble polymer to produce a treatment fluid comprising the plurality of particles dispersed in the carrier fluid.
15. The method according to embodiment 14, wherein the plurality of particles comprise a hydrolyzable polymer.
16. The method according to embodiment 14 or embodiment 15, wherein the treatment fluid comprises an Apollonianistic mixture of particles comprising proppant and particles comprising first and second particle size distribution modes,
wherein the first particle size distribution mode is from 1.5 to 25 times larger than the second particle size distribution mode,
wherein the first particle size distribution mode is smaller than the particle size distribution mode of the proppant, and
wherein the plurality of particles comprise at least one particle size distribution mode of the Apollonianistic mixture of particles.
17. The method according to any one of embodiments 14 to 16, further comprising circulating the treatment fluid into a wellbore.
18. The method according to any one of embodiments 14 to 17, further comprising forming a pack of the particles downhole.
19. The method according to any one of embodiments 14 to 18, wherein the pack comprises the proppant and at least one particle size distribution mode comprising a hydrolyzable polymer, and further comprising removing at least a portion of the hydrolyzable particles from the pack to form a permeable proppant pack.

20. The method according to any one of embodiments 14 to 19, further comprising producing or injecting a fluid through the permeable proppant pack.
21. The method according to any one of embodiments 14 to 20, wherein the permeable proppant pack comprises a gravel pack in an annulus between a screen and the wellbore.
22. The method according to any one of embodiments 14 to 21, wherein the permeable proppant pack is disposed in a fracture.
23. The method according to any one of embodiments 14-22, comprising: combining a carrier fluid, a solids mixture and a hydrolyzable fines dispersion to form a flowable slurry, wherein the solids mixture comprises a plurality of volume-averaged particle size distribution (PSD) modes, wherein a first PSD mode comprises solids having a volume-average median size at least three times larger than the volume-average median size of a second PSD mode such that a packed volume fraction (PVF) of the solids mixture exceeds 0.75 or exceeds 0.8, and wherein the solids mixture, e.g., the second PSD mode, comprises a degradable material and includes a reactive solid; circulating the slurry through a wellbore to form a pack of the solids mixture having a PVF exceeding 0.75 or exceeds 0.8 in one or both of a fracture in a formation and an annulus between a screen and the wellbore; degrading the degradable material in the pack to increase porosity and permeability of the pack; and producing a reservoir fluid from the formation through the increased porosity pack, and/or wherein the carrier fluid is a low viscosity fluid free of viscosifier or comprising viscosifier in an amount less than 2.4 g of viscosifier per liter of carrier fluid (20 lb/1000 gal).
24. The method according to embodiment 23, wherein the slurry is stable and has a high particulate loading comprising at least 2.6 kg of the solids mixture per liter of the carrier fluid (22 lb/gal).
25. The method according to any one of embodiments 23-24, wherein the first PSD mode comprises gravel and the second PSD mode comprises alumina trihydrate particles, and wherein the degradation comprises changing a pH in the pack to solubilize the alumina trihydrate particles.
26. The method according to any one of embodiments 23-25, wherein the degradable material is soluble in basic fluids and the degradation comprises increasing a pH in the pack to dissolve the degradable material.
27. The method according to any one of embodiments 23-26, comprising a degradable material, wherein the degradable material is selected from the group consisting of amphoteric oxides, esters, coated acids and combinations thereof.
28. The method according to any one of embodiments 23-27, wherein the solids mixture comprises base or base precursor.
29. The method according to any one of embodiments 23-28, wherein the base or base precursor is sparingly soluble or encapsulated.
30. The method according to any one of embodiments 23-29, wherein the base is selected from the group consisting of alkali metal and ammonium hydroxides, organic amines, urea, substituted urea and combinations thereof.
31. The method according to any one of embodiments 23-30, comprising contacting the pack with a basic aqueous solution.
31. The method according to any one of embodiments 23-31, wherein the degradable material is soluble in acidic fluids and the degradation comprises decreasing a pH in the pack to dissolve the degradable material, or wherein the degradable material is soluble in basic fluids and the degradation comprises increasing a pH in the pack to dissolve the degradable material.
32. The method according to any one of embodiments 23-31, wherein the degradable material is selected from the group consisting of oxides and hydroxides of aluminum, zinc, tin, lead, boron, silicon and iron; carbonates, sulfates, oxides and hydroxides of calcium, magnesium and barium; and combinations thereof.
33. The method according to any one of embodiments 23-32, wherein the particulates comprise an acid or acid precursor.
34. The method according to embodiment 33, wherein the acid or acid precursor is sparingly soluble or encapsulated.
35. The method according to any one of embodiments 32 or 33, wherein the acid precursor is selected from the group consisting of hydrolyzable esters, acid anhydrides, acid sulfonates, acid halides and combinations thereof.
36. The method according to any one of embodiments 23-35, comprising contacting a pack with an acidic aqueous solution.
37. The method according to any one of embodiments 23-36, comprising a plurality of PSD modes, wherein a second PSD mode comprises an encapsulated water- or oil-soluble solid, and the degradation comprises de-encapsulating the soluble solid.
38. The method according to any one of embodiments 23-37, comprising a plurality of PSD modes wherein the second PSD mode comprises a water-soluble solid and the carrier fluid comprises a saturated aqueous solution of the water-soluble solid, and the degradation comprises contacting the pack with an undersaturated aqueous medium.
39. The method according to any one of embodiments 23-37, comprising a plurality of PSD modes, wherein the second PSD mode comprises a water-soluble solid, and the carrier fluid comprises an invert oil emulsion wherein the water-soluble solid is dispersed in an oil phase, and the degradation comprises breaking the emulsion to dissolve the water-soluble solid in an aqueous medium.
40. The method according to any one of embodiments 23-39, comprising forming a pack and contacting the pack with a de-emulsifier to break the emulsion.
41. The method according to any one of embodiments 23-40, comprising forming a pack and contacting the pack with a pH control agent to break the emulsion.
42. The method according to embodiment 41, wherein the pH control agent is selected from the group consisting of monoesters, polyesters, weak acids, weak bases, urea, urea derivatives and combinations thereof.
43. The method according to any one of embodiments 23-39, wherein the particulates comprise a degradable material, wherein the degradable material comprises a water soluble material.
44. The method according to embodiment 43, wherein the carrier fluid is saturated with respect to the soluble material.
45. The method according to embodiment 43 or 44, wherein the soluble material comprises salt and the carrier fluid comprises brine.

### EXAMPLES

### Examples 1-4

### PLA/PVOH Extrusion Formulations

One specific example is a solid state dispersion made of polylactic acid (NATUREWORKS PLA 60600 or 6201 D resin) extruded with water soluble, G-polymer 8042P (NIPPON GOHSEI, MW 8042-13,000 g/mol). The extrusion was conducted using a THERMO HAAKE MINILAB micro-compounder. Table 1 shows the formulations and the extrusion conditions. The extruded PLLA/G8042P dispersions are visually transparent.

TABLE 1
PLA/PVOH Extrusion Formulations

| | | PVOH | PLA | | | |
|---|---|---|---|---|---|---|
| | Total | 8042P | 6060D | | Extrusion | Com- |
| | Weight | Weight | Weight | PLA | Temp. | pounding |
| Example | (g) | (g) | (g) | wt % | (° C.) | Time (min) |
| 1 | 6 | 5.4 | 0.6 | 10% | 180 | 6 |
| 2 | 6 | 5.4 | 0.6 | 10% | 180 | 6 |
| 3 | 8 | 6.4 | 1.6 | 20% | 180 | 6 |
| 4 | 8 | 6.4 | 1.6 | 20% | 180 | 6 |

Subsequent atomic force microscopy (AFM) images confirm the phase separation with the PLA droplets dispersed inside the water-soluble polymer phase in solid state. The pellets of Examples 3 and 4 were hot pressed to form a 0.3 mm thick film. AFM phase analyses on the film were conducted using alternating contact (AC) mode imaging (MW-3D, Asylum Research, Santa Barbara, Calif.). AFM cantilevers (AC24OTS, Olympus, Tokyo) with a nominal spring constant of 2 N−m−1. Phase images were acquired with a line scan rate of 1 Hz. The sizes of the PLA droplets were estimated to be from 20 nm to 100 nm.

The solid state dispersion of Example 1 was dissolved in water at room temperature to produce a 18 wt % PVOH polymer solution by weight of the liquid phase (2 wt % PLA particles by weight of the total fluid). The solid state dispersion of Example 3 was dissolved in water at room temperature to produce a 16 wt % aqueous PVOH polymer solution by weight of the liquid phase (4 wt % PLA particles by weight of the total fluid). Both of the solid state dispersions dissolved within three hours with minimal stirring at 25° C. to produce an emulsion comprising the insoluble PLA particles dispersed within the water soluble polymer aqueous solution. It was observed that the water soluble polymer was absorbed on the surface of the PLA particles, likely through H-bonding between PVOH polymer and the end group of PLA on the surface of PLA particles, which was thought to help stabilize the dispersion of the PLA particles in the aqueous polymer solution.

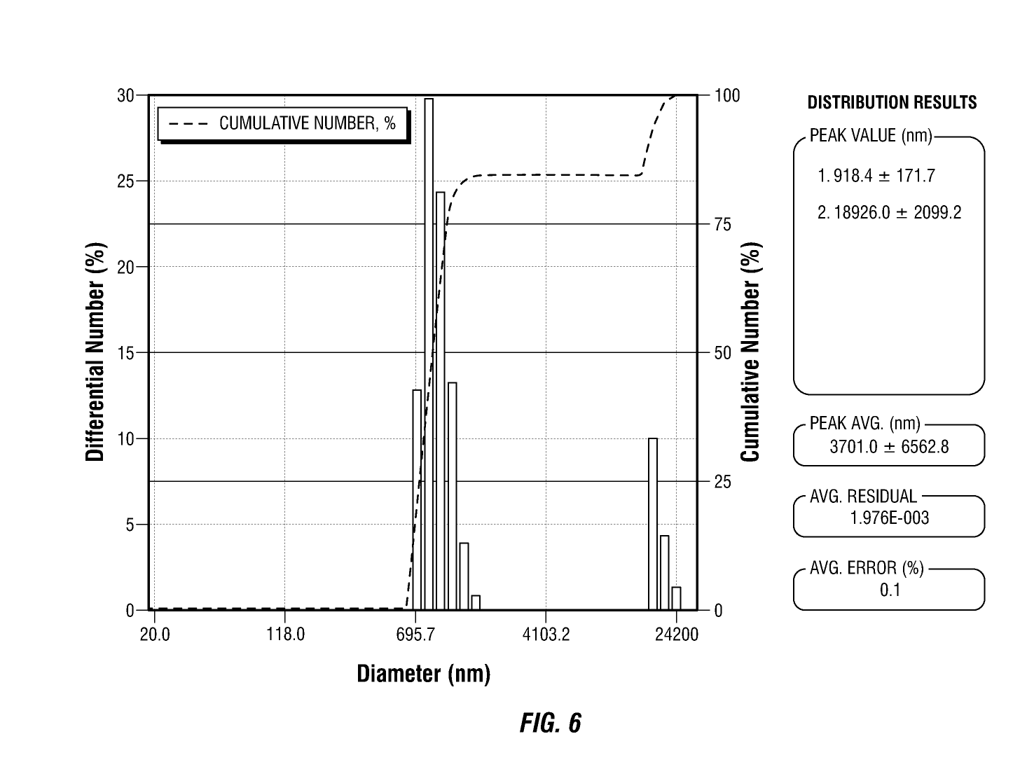

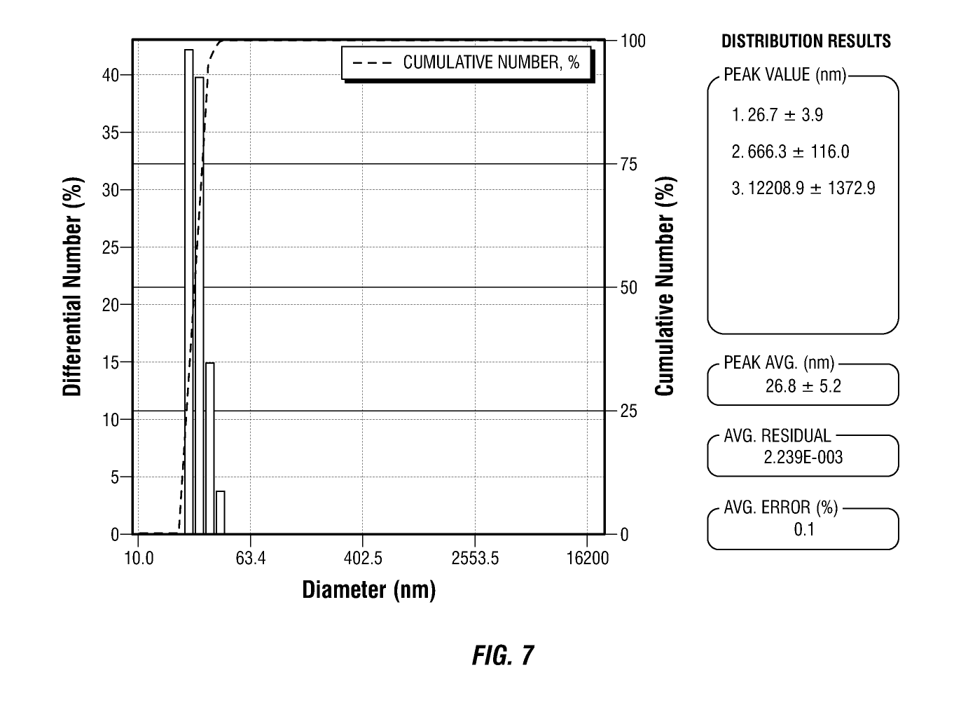

The particle sizes in the resulting emulsions were measured, using a DELSANANO light scattering (DLS) particle analyzer. FIG. 6 and FIG. 7 show the particle size distribution and the number average particle size of each emulsion. The number average particle size was 918 nm for the emulsion made from the solid state dispersion of Example 1 (10 wt % PLA) and 26.7 nm for the emulsion made from the solid state dispersion of Example 3 (20 wt % PLA). The sizes measured by DLS were consistent with those measured by AFM.

To further confirm that the dispersed particles are indeed the PLA particles, the particles were separated from the solution using an ALLEGRA X-2 Centrifuge (Beckman Coulter). After several cycles of centrifuging at 5000 RPM for 20 minutes, separating, and diluting, the solution phase became clear, indicating that the majority of PVOH-polymer was removed. The PLA particles were collected after filtering, washing and drying. Differential scanning calorimetry (DSC) measurement of the collected polymer agglomerates confirmed their identity. The DSC of the recovered PLA was consistent with the melting endothermic peak of the amorphous PLA at 131° C., and the absence of the melting endothermic of the PVOH resin at around 180° C., which is an indication of clean recovery of the PLA particles from the dispersion.

A control sample of PLA was dispersed in water and aged at 49° C. for two days to mimic the thermal and degradation history of the PLA recovered from the dissolved solid state dispersion. The recovered PLA had a lower glass transition temperature (Tg) and melting temperature relative to the control PLA, which indicated PLA degradation, suggesting that the fine PLA particles in the aqueous emulsion degrade faster than those in the solid state dispersion.

When applied to the surface of a glass slide, the emulsion formed a film as a result of dehydration and agglomeration or ‘coalescence’ of the emulsion particles at ambient environment.

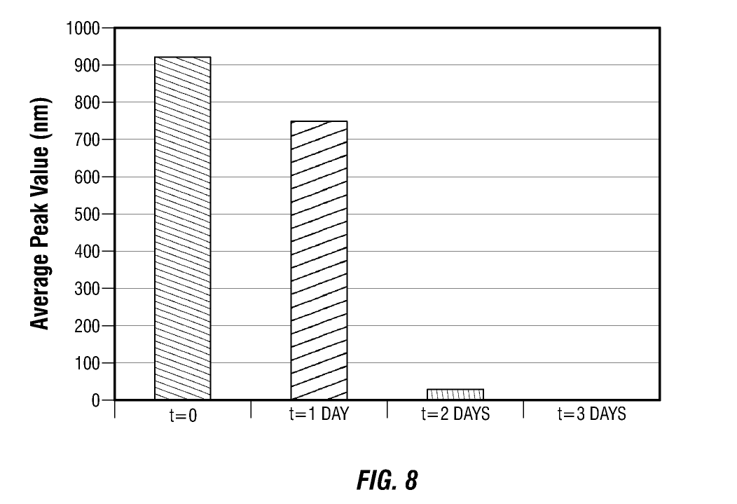

The degradation of the PLA emulsion was evident from the change of the PLA particle size under DLS measurement and from the visibly clearer solution after degradation at 60° C. in an oven for a period of time. FIG. 8 shows the change of the average particle size of the PLA (60600)/08042P emulsion after three days. The final pH of the emulsion after all PLA was degraded was 2.84. PLA degradation can be accelerated under basic or acidic conditions, or at elevated temperatures. Accordingly, embodiments of the instant disclosure result in an improvement in fluid loss control, in addition, the degradable nature of the dispersion improves cleanup and subsequent production of fluid from the well.

### Example 5

### Solids/PLA/PVOH Mixed and Dried Formulations

Calcium carbonate (CaCO3, 2 micron) and silica (30 micron) particles were mixed at a weight ratio of 1:6 and then 4.85 g of the mixture were added into 1 ml of 7 wt % aqueous solution of PVOH which contained 1.4 wt % PLA solids. The solution and the solid particles were further mixed using a spatula until a thick (cookie dough) mixture was formed. The mixture was dried to form a solid block with multimodal and multifunctional particles. The solid state dispersion in the dried block was 98 wt % solids. The dried solid state dispersion (2.85 g) was easily re-dissolved in 1 ml of water to form a thick slurry within a few minutes. Accordingly, the instant solid state dispersion may include a plurality of solids having different PSD modes, and may be produced by mixing and drying as well as by melt extrusion or other methods.

This example shows that industrial bulk molding compound (BMC) processes may be used to make the particle-filled polymer blocks, bricks or pellets. In the BMC process, the fillers, fibers, and polymer resin are mixed and then extruded. This process may be used to mix fillers and the degradable emulsion, extrude to form pellets and dry in an oven or may be used in a high temperature compression molding process.

### Example 6

### Solids/PVOH Extrusion Formulations

Solid particle-filled pellets according to embodiments were prepared via extrusion. The mixture of solid particles with different average sizes was extruded with the water soluble polymer/PLA dispersion to form particle-filled rods and pellets. The extrusion was conducted using a THERMO-HAAKE MINILAB microcompounder at 180° C., i.e., the extrusion temperature was at or about 10° C. above the melting temperature of the polymer. The resulting rod was then cut into pellets. The components and amounts of an exemplary composition according to the instant disclosure are shown in Table 2.

TABLE 2
Example 6 exemplary extrusion formulation.

| Component/Ratio | | |
|---|---|---|
| PVOH 8042P G-Polymer | 4.8 | g |
| CaCO₃ | 2.88 | |
| Silica, 30 micron particles | 1.92 | |
| CaCO₃/silica weight ratio | 1.5 | |
| Total solids | 60 | wt % |

Two grams of the pellets were dissolved in 4.2 g water to produce a saturated polymer suspension with 28.6 vol % solid particles. The dissolution took 2 hours. An aliquot of the suspension was dried and prepared for scanning electron microscopy (SEM) imaging, which showed solid particles dispersed in the polymer.

The loading of the solid particles in the composite pellets may in some embodiments be limited by the melt flow index (MFI) of the polymer and the concentration of the solid particles, which may be as much as 70 vol % in some embodiments.

This example shows that upon water exposure, the pellets will dissolve and release the particles within a few hours. The minimum water required for dissolving the pellets depends on the solubility of the water soluble polymer. The minimum water required for dissolving the pellets at a given temperature, VH2O, may be estimated as the weight of the pellet, Wm, multiplied by the weight percent of the soluble polymer (1 minus the weight percent of the solid particles in the composite, S), and divided by the solubility c of the water soluble polymer in water (g polymer per 100 g of water): VH2O=Wm*(100−S %)/c.

While the embodiments have been illustrated and described in detail in the drawings and foregoing description, the same is to be considered as illustrative and not restrictive in character, it being understood that only some embodiments have been shown and described and that all changes and modifications that come within the spirit of the embodiments are desired to be protected. It should be understood that while the use of words such as ideally, desirably, preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

We claim:

1. A composition comprising a solid state dispersion comprising a plurality of particles dispersed in a matrix comprising a water soluble polymer.

2. The composition of claim 1, wherein the plurality of particles comprise a hydrolyzable polymer.

3. The composition of claim 2, wherein the hydrolyzable polymer is immiscible with the water soluble polymer.

4. The composition of claim 2, wherein the hydrolyzable polymer is acid labile.

5. The composition of claim 2, further comprising particles comprising silicates, γ-alumina, MgO, γ-Fe₂O₃, TiO₂, and combinations thereof.

6. The composition of claim 1, wherein the plurality of particles comprises a polyester.

7. The composition of claim 1, wherein the plurality of particles comprise polylactic acid, polyglycolic acid, polycarprolactone, polybutylene succinate, polybutylene succinate-co-adipate, polyhydroxyalkanoate polymers or a combination thereof.

8. The composition of claim 1, wherein the water soluble polymer comprises polyvinyl alcohol, polyethylene oxide, sulfonated polyester, polyacrylic ester/acrylic acid copolymer, polyacrylic ester/methacrylic acid copolymer, polyethylene glycol, poly (vinyl pyrrolidone), polylactide-co-glycolide, ethyl cellulose, hydroxypropylcellulose, hydroxypropylmethylcellulose, aminomethacrylatecolpolymer, polydimethlyaminoethylmethacrylate-co-methacrylicester, polymethacyrlicacid-co-methylmethacrylate, guar, hydroxyethylcellulose, xanthan, or a combination thereof.

9. The composition of claim 1, wherein at least some of the plurality of particles comprise an average particle size from about 0.001 microns to about 20 microns.

10. The composition of claim 1, comprising from about 1 wt % to 90 wt % of the plurality of particles, based on the total weight of the composition.

11. The composition of claim 1, further comprising from about 0.1 wt % to about 50 wt % of a dispersant, a surfactant, a viscosifier, a defoamer, a plasticizer, or a combination thereof, based on the total weight of the composition.

12. The composition of claim 1, wherein the plurality of particles comprise an Apollonianistic mixture of particles comprising first and second particle size distribution modes wherein the first particle size distribution mode is from 1.5 to 25 times larger than the second particle size distribution mode.

13. The composition of claim 1, wherein the solid state dispersion is a melt extrudate.

14. A method comprising:
contacting a solid state dispersion comprising a plurality of particles dispersed in a matrix comprising a water soluble polymer, with an aqueous carrier fluid at a temperature and for a period of time sufficient to dissolve at least a portion of the water soluble polymer to produce a treatment fluid comprising the plurality of particles dispersed in the carrier fluid.

15. The method of claim 14, wherein the plurality of particles comprise a hydrolyzable polymer.

16. The method of claim 14, wherein the treatment fluid comprises an Apollonianistic mixture of particles comprising proppant and particles comprising first and second particle size distribution modes,
wherein the first particle size distribution mode is from 1.5 to 25 times larger than the second particle size distribution mode,
wherein the first particle size distribution mode is smaller than the particle size distribution mode of the proppant, and
wherein the plurality of particles comprise at least one particle size distribution mode of the Apollonianistic mixture of particles.

17. The method of claim 14, further comprising circulating the treatment fluid into a wellbore.

18. The method of claim 17, further comprising forming a pack of the particles downhole.

19. The method of claim 17, wherein the pack comprises the proppant and at least one particle size distribution mode comprising a hydrolyzable polymer, and further comprising removing at least a portion of the hydrolyzable particles from the pack to form a permeable proppant pack.

20. The method of claim 19, further comprising producing or injecting a fluid through the permeable proppant pack.

21. The method of claim 19, wherein the permeable proppant pack comprises a gravel pack in an annulus between a screen and the wellbore.

22. The method of claim 19, wherein the permeable proppant pack is disposed in a fracture.

23. A method comprising:
dispersing a plurality of particles as a discontinuous phase in a continuous phase comprising a water soluble polymer to produce a solid state dispersion.

24. The method of claim 23, wherein the plurality of particles comprise a hydrolyzable polymer which is immiscible with the water soluble polymer.

25. The method of claim 23, wherein the plurality of particles is dispersed in a melt extrusion, followed by cooling of the melt extrudate to produce the solid state dispersion.
